(19) United States
(12) Patent Application Publication
(10) Pub. No.: US 2024/0017251 A1
(43) Pub. Date: Jan. 18, 2024

(54) SYSTEMS AND METHODS FOR COLLECTING FLUIDS

(71) Applicant: Sunflower Therapeutics, PBC, Hingham, MA (US)

(72) Inventors: Alexandra Bonnyman, Weymouth, MA (US); John Christopher Love, Somerville, MA (US); Larry Weiner, Newton, MA (US)

(21) Appl. No.: 18/364,857

(22) Filed: Aug. 3, 2023

Related U.S. Application Data
(60) Provisional application No. 63/487,664, filed on Mar. 1, 2023.

(51) Int. Cl. B01L 3/00

(52) U.S. Cl. CPC B01L 3/5025; B01L 3/52; B01L 3/567

(57) ABSTRACT

Disclosed are systems and methods for alternately collecting a fluid in a plurality of containers without breaching its sterility. The system generally includes one or more collection modules, each having a valve and one or more container sets fluidically connected to the valve. Each container set includes first and second containers. The system also includes a control unit to control operation of the valve of each collection module to facilitate alternate collection of the fluid by the first and second containers of a container set. This may ensure that the fluid collected in one container is a true representative sample of the fluid collected in the container without compromising its sterile integrity.

### CROSS-REFERENCE TO RELATED APPLICATION(S)

The present application claims priority to U.S. Provisional Patent Application No. 63/487,664 filed Mar. 1, 2023. The disclosure of the application is incorporated herein for all purposes by reference in its entirety.

### TECHNICAL FIELD

The present invention generally relates to systems and methods for collecting fluids.

### BACKGROUND

Biopharmaceuticals and vaccines are commonly produced or manufactured using a series of operations intended to express, recover, and stabilize proteins or other pharmaceutical ingredients as part of a manufacturing process. These operations involve the delivery, transfer, and disposal of one or more fluid media and buffers including combinations of salts, chemicals, and other substances intended to support specific steps in the production process. Examples of such operations include cell cultivation or fermentation, buffer exchange, chromatography, concentration, precipitation, separation, and crystallization.

In many cases, prior to performing the next operation, a representative sample must be collected for analytic testing without breaching the sterility of the substances. For instance, in some cases, formulated substances from an upstream operation such as a filtration process must be collected in a bulk sterile container for later processing. Removing a sample for the bulk sterile container could breach the sterility of the formulated substances.

Hence, there is a need for systems and methods that address the above-mentioned issues.

### SUMMARY

The present invention addresses the above mentioned issues and/or other issues by providing systems and methods that use different containers in a container set to alternately connect a product without breaching the sterility of the product.

In various embodiments, the present invention provides a system including a collection system including one or more collection modules and a control unit. Each collection module in the one or more collection modules includes a valve and one or more container sets. The valve has an inlet and one or more outlet sets. Each outlet set in the one or more outlet sets includes a first outlet and a second outlet, and any outlet of any outlet set in the one or more outlet sets is individually selectable for fluidically coupling with the inlet. Each respective container set in the one or more container sets includes a first container fluidically connected to the first outlet of a corresponding outlet set in the one or more outlet sets and a second container fluidically connected to the second outlet of the corresponding outlet set in the one or more outlet sets. For a first collection module in the one or more collection modules: (i) the inlet of the valve is configured to be fluidically connected to an upstream system to receive a first stream of fluid from the upstream system, (ii) the one or more outlet sets include a first outlet set, (iii) the one or more container sets include a first container set, (iv) the first container of the first container set is fluidically connected to the first outlet of the first outlet set, and (v) the second container of the first container set is fluidically connected to the second outlet of the first outlet set. The control unit is electrically connected to the valve of each collection module in the one or more collection modules and configured to control operation of the valve of each collection module in the one or more collection modules. For the first collection module in the one or more collection modules, the control of operation of the valve includes alternately coupling the first outlet and the second outlet of the first outlet set with the inlet a first plurality of times, thereby allowing the first container and the second container of the first container set to alternately collect the first stream of fluid.

In some embodiments, the fluid includes proteins, peptides, cells, nucleic acids, vaccines, diagnostics, reagents, raw materials, or any combination thereof.

In some embodiments, the fluid includes a biological component. In some embodiments, the biological component is a biopharmaceutical or vaccine product or a component of the biopharmaceutical or vaccine product. In some embodiments, the biopharmaceutical product includes proteins, peptides, cells, nucleic acids, vaccines, biopolymers, carbohydrates, polysaccharides, lipids, biosynthetic molecules, molecules produced by, for example, biocatalysis or enzymatic production, or any combination thereof.

In some embodiments, for each collection module in the one or more collection modules, at least one outlet set in the one or more outlet sets further includes a third outlet configured to be fluidically connected to a downstream system. In some embodiments, for each collection module in the one or more collection modules, each outlet set in the one or more outlet sets further includes the third outlet configured to be fluidically connected to the downstream system.

In some embodiments, for each collection module in the one or more collection modules, the first container of each respective container set in the one or more container sets is fluidically connected to the first outlet of the corresponding outlet set in the one or more outlet sets through a first filter, a first disconnection device, or both. In addition, the second container of each respective container set in the one or more container sets is fluidically connected to the second outlet of the corresponding outlet set in the one or more outlet sets through a second filter, a second disconnection device, or both.

In some embodiments, for each collection module in the one or more collection modules, the one or more outlet sets of the valve includes one, two, three, four, five, six, seven, eight, nine, ten, or more than ten outlet sets. In some embodiments, for each collection module in the one or more collection modules, the one or more container sets include one, two, three, four, five, six, seven, eight, nine, ten, or more than ten container sets.

In some embodiments, for at least one collection module in the one or more collection modules, the one or more outlet sets of the valve have a same number of sets as the one or more container sets. In some embodiments, for at least one collection module in the one or more collection modules, the one or more outlet sets of the valve have a greater number of sets than the one or more container sets.

In some embodiments, for at least one collection module in the one or more collection modules, the first and second containers of a respective container set in the one or more container sets are configured differently. In some embodiments, the first container of the respective container set in the one or more container sets is configured to collect a first amount of fluid, and the second container of the respective container set in the one or more container sets is configured to collect a second amount of fluid. In some embodiments, the first or second amount of the fluid is collected for sample testing. In some embodiments, for at least one collection module in the one or more collection modules, the first or second container of a respective container set in the one or more container sets is a bag, a bottle or a carboy.

In some embodiments, for the first collection module in the one or more collection modules, the coupling of the first outlet and the second outlet of the first outlet set with the inlet alternates at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, at least 100 times, at least 150 times, or at least 200 times.

In some embodiments, for the first collection module in the one or more collection modules and at a respective alternation, the coupling of the first outlet of the first outlet set with the inlet lasts for a first period of time and the coupling of the second outlet of the first outlet set with the inlet lasts for a second period of time. In some embodiments, the first period of time is determined based at least in part on (i) a total amount of fluid to be collected by the first container of the first container set, (ii) a current amount of fluid in the first container of the first container set, (iii) a rate of filling the first container of the first container set (e.g., a flow rate of fluid to the first container of the first container set), or any combination thereof. The second period of time is determined based at least in part on (i) a total amount of fluid to be collected by the second container of the first container set, (ii) a current amount of fluid in the second container of the first container set, (iii) a rate of filling the second container of the first container set (e.g., a flow rate of fluid to the second container of the first container set), or any combination thereof.

In some embodiments, for the first collection module in the one or more collection modules, the first outlet set further includes a third outlet fluidically connected to a downstream system, and the control of operation of the valve includes, prior to alternately coupling the first outlet and the second outlet of the first outlet set with the inlet, coupling the third outlet of the first outlet set with the inlet, thereby allowing flushing the valve with the first stream of fluid.

In some embodiments, for the first collection module in the one or more collection modules: (i) the one or more outlet sets further include a second outlet set, (ii) the one or more container sets further include a second container set, (iii) the first container of the second container set is fluidically connected to the first outlet of the second outlet set, (iv) the second container of the second container set is fluidically connected to the second outlet of the first outlet set, and (v) the control of operation of the valve further includes, subsequent to alternately coupling the first outlet and the second outlet of the first outlet set with the inlet, alternately coupling the first outlet and second outlet of the second outlet set with the inlet a second plurality of times, thereby allowing the first container and second container of the second container set to alternately collect the first stream of fluid.

In some embodiments, for the first collection module in the one or more collection modules, the coupling of the first and second outlets of the second outlet set with the inlet alternates at least 2 times, at least 3 times, at least 4 times, at least 5 times, at least 10 times, at least 15 times, at least 20 times, at least 30 times, at least 40 times, at least 50 times, at least 60 times, at least 70 times, at least times, at least 90 times, at least 100 times, at least 150 times, or at least 200 times.

In some embodiments, for the first collection module in the one or more collection modules, the second outlet set further includes a third outlet fluidically connected to a downstream system, and the control of operation of the valve includes, subsequent to alternately coupling the first outlet and the second outlet of the first outlet set with the inlet but prior to alternately coupling the first outlet and the second outlet of the second outlet set with the inlet, coupling the third outlet of the second outlet set with the inlet, thereby allowing flushing the valve with the first stream of fluid.

In some embodiments, the one or more collection modules consist of the first collection module. In some other embodiments, the one or more collection modules includes two, three, four, five, six or more than six collection modules.

In some embodiments, the one or more collection modules includes the first collection module and a second collection module. In some embodiments, the one or more outlet sets of the valve of the second collection module have a same number of sets as the one or more outlet sets of the valve of the first collection module. In some other embodiments, the one or more outlet sets of the valve of the second collection module have a different number of sets than the one or more outlet sets of the valve of the first collection module. In some embodiments, the one or more container sets of the second collection module have a same number of sets as the one or more container sets of the first collection module. In some other embodiments, the one or more container sets of the second collection module have a different number of sets than the one or more container sets of the first collection module.

In some embodiments, for the second collection module in the one or more collection modules: (i) the inlet of the valve is configured to be fluidically connected to the upstream system to receive a second stream of fluid from the upstream system, (ii) the one or more outlet sets include a first outlet set, (iii) the one or more container sets include a first container set, (vi) the first container of the first container set is fluidically connected to the first outlet of the first outlet set, (v) the second container of the first container set is fluidically connected to the second outlet of the first outlet set, and (vi) the control of operation of the valve includes alternately coupling the first outlet and the second outlet of the first outlet set with the inlet a third plurality of times, thereby allowing the first container and the second container of the first container set to alternately collect the second stream of fluid.

In some embodiments, for the second collection module in the one or more collection modules, the first outlet set further includes a third outlet fluidically connected to a downstream system, and the control of operation of the valve includes, prior to alternately coupling the first outlet and the second outlet of the first outlet set with the inlet, coupling the third outlet of the first outlet set with the inlet, thereby allowing flushing the valve with the second stream of fluid.

In some embodiments, for the second collection module in the one or more collection modules: (i) the one or more outlet sets further include a second outlet set, (ii) the one or more container sets further include a second container set, (iii) the first container of the second container set is fluidically connected to the first outlet of the second outlet set, (iv) the second container of the second container set is fluidically connected to the second outlet of the first outlet set, and (v) the control of operation of the valve further includes, subsequent to alternately coupling the first outlet and the second outlet of the first outlet set with the inlet, alternately coupling the first outlet and second outlet of the second outlet set with the inlet a fourth plurality of times, thereby allowing the first container and second container of the second container set to alternately collect the second stream of fluid.

In some embodiments, for the second collection module in the one or more collection modules, the second outlet set further includes a third outlet fluidically connected to a downstream system, and the control of operation of the valve includes, subsequent to alternately coupling the first outlet and the second outlet of the first outlet set with the inlet but prior to alternately coupling the first outlet and the second outlet of the second outlet set with the inlet, coupling the third outlet of the second outlet set with the inlet, thereby allowing flushing the valve with the second stream of fluid.

In some embodiments, the control of operation of the valve of the first collection module and the control of operation of the valve of the second collection module are independent from each other.

In some embodiments, the inlet of the valve of the first collection module and the inlet of the valve of the second collection module are fluidically connected to the upstream system through a common upstream connector. In some other embodiments, the inlet of the valve of the first collection module and the inlet of the valve of the second collection module are fluidically connected to the upstream system through different upstream connectors.

In some embodiments, for the first collection module in the one or more collection modules, the valve further includes a transfer outlet, and the control of operation of the valve includes coupling the transfer outlet with the inlet. For the second collection module in the one or more collection modules: (i) the inlet of the valve is fluidically connected to the transfer outlet of the valve of the first collection module to receive the first stream of fluid, (ii) the one or more outlet sets include a first outlet set, (iii) the one or more container sets include a first container set, (iv) the first container of the first container set is fluidically connected to the first outlet of the first outlet set, (v) the second container of the first container set is fluidically connected to the second outlet of the first outlet set, and (vi) the control of operation of the valve includes alternately coupling the first outlet and the second outlet of the first outlet set with the inlet a fifth plurality of times, thereby allowing the first container and the second container of the first container set to alternately collect the first stream of fluid.

In some embodiments, for the second collection module in the one or more collection modules, the first outlet set further includes a third outlet fluidically connected to a downstream system, and the control of operation of the valve includes, prior to alternately coupling the first outlet and the second outlet of the first outlet set with the inlet, coupling the third outlet of the first outlet set with the inlet, thereby allowing flushing the valve with the first stream of fluid.

In some embodiments, for the second collection module in the one or more collection modules: (i) the one or more outlet sets further include a second outlet set, (ii) the one or more container sets further include a second container set, (iii) the first container of the second container set is fluidically connected to the first outlet of the second outlet set, (iv) the second container of the second container set is fluidically connected to the second outlet of the first outlet set, and (v) the control of operation of the valve further includes, subsequent to alternately coupling the first outlet and the second outlet of the first outlet set with the inlet, alternately coupling the first outlet and second outlet of the second outlet set with the inlet a sixth plurality of times, thereby allowing the first container and second container of the second container set to alternately collect the first stream of fluid.

In some embodiments, for the second collection module in the one or more collection modules, the second outlet set further includes a third outlet fluidically connected to a downstream system, and the control of operation of the valve includes, subsequent to alternately coupling the first outlet and the second outlet of the first outlet set with the inlet but prior to alternately coupling the first outlet and the second outlet of the second outlet set with the inlet, coupling the third outlet of the second outlet set with the inlet, thereby allowing flushing the valve with the first stream of fluid.

In some embodiments, the one or more collection modules includes the first collection module, the second collection module and a third collection module. In some embodiments, the control of operation of the valve of the third connection module is independent of the control of operation of the valve of the first collection module, the control of operation of the valve of the second collection module, or both.

In some embodiments, for the third collection module in the one or more collection modules: (i) the inlet of the valve is configured to be fluidically connected to the upstream system to receive a third stream of fluid from the upstream system, (ii) the one or more outlet sets include a first outlet set, (iii) the one or more container sets include a first container set, (iv) the first container of the first container set is fluidically connected to the first outlet of the first outlet set, (v) the second container of the first container set is fluidically connected to the second outlet of the first outlet set, and (vi) the control of operation of the valve includes alternately coupling the first outlet and the second outlet of the first outlet set with the inlet a seventh plurality of times, thereby allowing the first container and the second container of the first container set to alternately collect the third stream of fluid.

In some embodiments, for the third collection module in the one or more collection modules, the first outlet set further includes a third outlet fluidically connected to a downstream system, and the control of operation of the valve includes, prior to alternately coupling the first outlet and the second outlet of the first outlet set with the inlet, coupling the third outlet of the first outlet set with the inlet, thereby allowing flushing the valve with the third stream of fluid.

In some embodiments, for the third collection module in the one or more collection modules: (i) the one or more outlet sets further include a second outlet set, (ii) the one or more container sets further include a second container set, (iii) the first container of the second container set is fluidically connected to the first outlet of the second outlet set, (iv) the second container of the second container set is fluidically connected to the second outlet of the first outlet set, and (v) the control of operation of the valve further includes, subsequent to alternately coupling the first outlet and the second outlet of the first outlet set with the inlet, alternately coupling the first outlet and second outlet of the second outlet set with the inlet an eighth plurality of times, thereby allowing the first container and second container of the second container set to alternately collect the third stream of fluid.

In some embodiments, for the third collection module in the one or more collection modules, the second outlet set further includes a third outlet fluidically connected to a downstream system, and the control of operation of the valve includes, subsequent to alternately coupling the first outlet and the second outlet of the first outlet set with the inlet but prior to alternately coupling the first outlet and the second outlet of the second outlet set with the inlet, coupling the third outlet of the second outlet set with the inlet, thereby allowing flushing the valve with the third stream of fluid.

In some embodiments, each outlet set in the one or more outlet sets includes at least one additional outlet. Each respective container set in the one or more container sets may include at least one additional container, with each of the at least one additional container fluidically connected to a corresponding additional outlet in the at least one additional outlet of a corresponding outlet set in the one or more outlet sets. In some such embodiments, for the first collection module in the one or more collection modules, the control of operation of the valve includes alternately coupling the first outlet, the second outlet, and each of the at least one additional outlet of the first outlet set with the inlet the first plurality of times, thereby allowing the first container, the second container, and each of the at least one additional container of the first container set to alternately collect the first stream of fluid.

In some embodiments, each outlet set in the one or more outlet sets includes one, two, three, four or five additional outlets, and each respective container set in the one or more container sets includes one, two, three, four, or five additional containers.

In various embodiments, the present invention provides a method for controlling a collection system disclosed herein.

In various embodiments, the present invention provides a method for controlling a system that includes a valve and one or more container sets. The valve includes an inlet for receiving a stream of fluid and one or more outlet sets for fluidically coupling with the one or more container sets. Each of the one or more outlet sets includes a first outlet and a second outlet and any outlet of any outlet set in the one or more outlet sets is individually selectable for fluidically coupling with the inlet. Each of the one or more container sets includes a first container and a second container, and the first and second containers of a first container set are fluidically connected to the first and second outlets of a first outlet set respectively. The method includes (A) alternately coupling the first outlet and the second outlet of the first outlet set with the inlet a first plurality of times, thereby allowing the first container and the second container of the first container set to alternately collect the stream of fluid.

In some embodiments, the coupling of the first outlet and the second outlet of the first outlet set with the inlet alternates at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, or at least 100 times. In some embodiments, at a respective alternation, the coupling of the first outlet of the first outlet set with the inlet lasts for a first period of time and the coupling of the second outlet of the second outlet set with the inlet lasts for a second period of time. In some embodiments, the first period of time is determined based at least in part on (i) a total amount of fluid to be collected by the first container of the first container set, (ii) a current amount of fluid in the first container of the first container set, (iii) a rate of filling the first container of the first container set, or any combination thereof. The second period of time is determined based at least in part on (i) a total amount of fluid to be collected by the second container of the first container set, (ii) a current amount of fluid in the second container of the first container set, (iii) a rate of filling the second container of the first container set, or any combination thereof.

In some embodiments, the first container of the first container set is configured to collect a first amount of fluid, and the second container of the first container set is configured to collect a second amount of fluid. In some embodiments, the first or second amount of the fluid is collected for sample testing.

In some embodiments, the first outlet set further includes a third outlet fluidically connected to a downstream system. In some such embodiments, the method further includes (B) coupling, prior to the alternately coupling (A), the third outlet of the first outlet set with the inlet, thereby allowing flushing the valve with the stream of fluid.

In some embodiments, the one or more outlet sets further include a second outlet set, the one or more container sets further include a second container set, and the first and second containers of the second container set are fluidically connected to the first and second outlets of the second outlet set respectively. In some such embodiments, the method further includes (C) alternately coupling, subsequent to the alternately coupling (A), the first outlet and second outlet of the second outlet set with the inlet a second plurality of times, thereby allowing the first container and second container of the second container set to alternately collect the stream of fluid. In some embodiments, the second plurality of times is the same as the first plurality of times. In some other embodiments, the second plurality of times is different than the first plurality of times.

In some embodiments, the second outlet set further includes a third outlet fluidically connected to the downstream system. In some such embodiments, the method further includes (D) coupling, subsequent to the alternately coupling (A) but prior to the alternately coupling (C), the third outlet of the second outlet set with the inlet, thereby allowing flushing the valve with the stream of fluid.

In some embodiments, the method further includes (E) prohibiting the first outlet and the second outlet of the first outlet set from coupling with the inlet during the alternately coupling (B), thereby preventing contamination between the first container and second container of the first container set and the first container and second container of the second container set.

The systems and methods of the present disclosure have other features and advantages that will be apparent from, or are set forth in more detail in, the accompanying drawings, which are incorporated herein, and the following Detailed Description, which together serve to explain certain principles of exemplary embodiments of the present disclosure.

### BRIEF DESCRIPTION OF THE DRAWINGS

The foregoing summary, as well as the following detailed description of exemplary embodiments, will be better understood when read in conjunction with the appended drawings of exemplary embodiments. It should be understood, however, that the invention is not limited to the precise arrangements and instrumentalities shown.

In the drawings:

FIG. 1 is a block diagram illustrating an exemplary collection module or system in accordance with some exemplary embodiments of the present invention;

FIG. 2 is a block diagram illustrating an exemplary control unit in accordance with some exemplary embodiments of the present invention;

FIG. 3 is a block diagram illustrating an exemplary collection system in accordance with some exemplary embodiments of the present invention;

FIG. 4 is a block diagram illustrating a first example of the exemplary collection system of FIG. 3 in accordance with some exemplary embodiments of the present invention;

FIG. 5 is a block diagram illustrating a second example of the exemplary collection system of FIG. 3 in accordance with some exemplary embodiments of the present invention;

FIG. 6 is an enlarged view of FIG. 5 (partial);

FIG. 7 is a block diagram illustrating a third example of the exemplary collection system of FIG. 3 in accordance with some exemplary embodiments of the present invention;

FIG. 8 is a block diagram illustrating a fourth example of the exemplary collection system of FIG. 3 in accordance with some exemplary embodiments of the present invention; and

FIG. 9 is a block diagram illustrating a fifth example of the exemplary collection system of FIG. 3 in accordance with some exemplary embodiments of the present invention;

FIG. 10 is a flowchart illustrating an exemplary method, in which the preferred parts of the method are shown in solid line boxes whereas additional, optional, or alterative parts of the method are shown in dashed line boxes, in accordance with some exemplary embodiments of the present invention.

### DETAILED DESCRIPTION

The present invention is directed to systems and methods for alternately collecting a fluid in a plurality of containers without breaching its sterility. A system of the present invention generally includes one or more collection modules, each having a valve and one or more container sets fluidically connected to the valve. Each container set includes a plurality of containers such as two, three, four, five or more than five containers. A system of the present invention also includes a control unit to control operation of the valve of each collection module to facilitate alternate collection of the fluid by the plurality of containers of a container set.

Before the invention is described in greater detail, it is to be understood that the invention is not limited to particular embodiments described herein as such embodiments may vary. It is also to be understood that the terminology used herein is for the purpose of describing particular embodiments only, and the terminology is not intended to be limiting. The scope of the invention will be limited only by the appended claims. Unless defined otherwise, all technical and scientific terms used herein have the same meaning as commonly understood by one of ordinary skill in the art to which this invention belongs. Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

It is noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method may be carried out in the order of events recited or in any other order that is logically possible.

As used in the description of the implementations and the appended claims, the singular forms “a”, “an” and “the” are intended to include the plural forms as well, unless the context clearly indicates otherwise. It will be understood that, although the terms “first,” “second,” etc. may be used herein to describe various elements, these elements should not be limited by these terms. These terms are only used to distinguish one element from another. For example, a first element could be termed a second element, and, similarly, a second element could be termed a first element, without changing the meaning of the description, so long as the “first element” and the “second element” are renamed consistently.

The term “and/or” as used herein refers to and encompasses any and all possible combinations of one or more of the associated listed items. It will be further understood that the terms “include”, “includes”, “including”, “comprise”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “about” or “approximately” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number. It should be appreciated that all numerical values and ranges disclosed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is disclosed herein, any numerical value falling within the range is also specifically disclosed.

The term “if” used herein is, optionally, construed to mean “when” or “upon” or “in response to determining” or “in response to detecting” or “in accordance with a determination that,” depending on the context. Similarly, the phrase “if it is determined” or “if [a stated condition or event] is detected” used herein is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

When a reference number is given an “i^{th}” denotation, the reference number refers to a generic component, set, or embodiment. For instance, a “unit i” refers to the i^{th} unit in a plurality of units.

The term “fluidically connected” used herein refers to two or more components (e.g., a valve and an upstream system, an intel and an outlet of a valve, a valve and a collection container, etc.) connected, for instance by conduit(s), channel(s), connector(s) or the like, such that a fluid can flow from one component to another. The fluidic connection between two components can be direct, i.e., there is no other component between the two components except the conduit(s), channel(s), connector(s) or the like that connects the two components. The fluidic connection between two components can also be indirect, i.e., there is at least one component between the two components in addition to the conduit(s), channel(s), connector(s) or the like that connects the two components. For instance, in some embodiments, a valve is fluidically connected to an upstream system through another valve that is fluidically connected to the upstream system.

The term “electrically connected” used herein refers to two or more components (e.g., a control unit and a sensor) connected by wire or wireless (e.g., using a cable or a network) such that electrical signals can flow from one component to another.

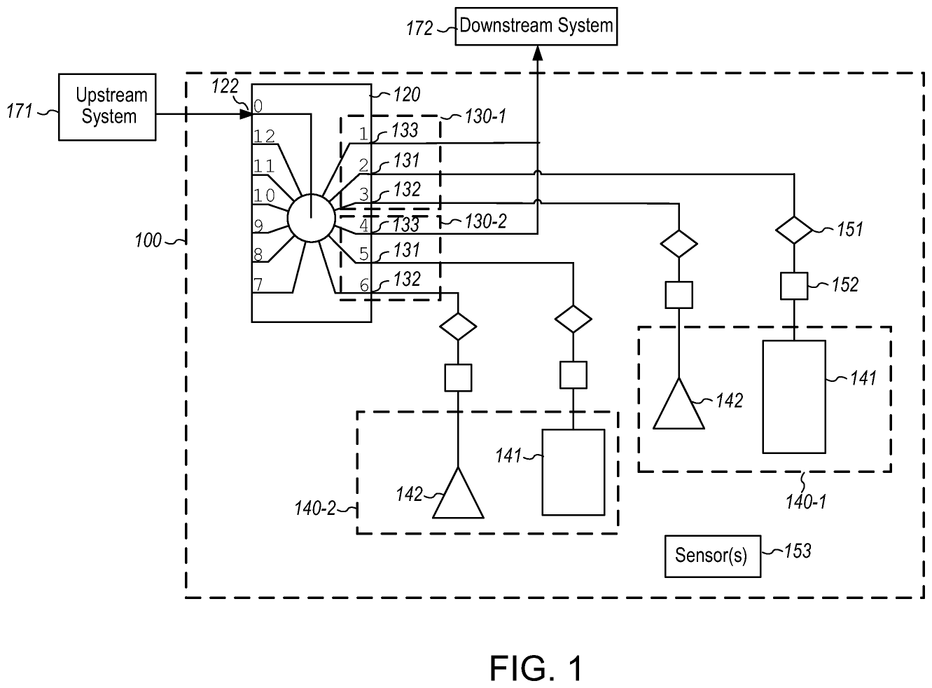

FIG. 1 illustrates an exemplary collection module, generally designated 100, in accordance with some exemplary embodiments of the present invention. The collection module includes a valve 120. The valve 120 includes an inlet 122 (e.g., the inlet labeled “0”) and a plurality of outlets (e.g., the outlets labeled “1”, “2”, “3” etc.). The valve 120 can include any suitable number of outlets. For instance, in some embodiments, the valve includes 2, 3, 4, 5, 6, 7, 8, 9, 10, 11, 12, 13, 14, or 15 outlets. In some embodiments, the valve includes at least 6, at least 8, at least 10, at least 12, at least 15, at least 20 outlets, at least 25, or at least 20 outlets. By way of example, FIG. 1 illustrates the valve 120 having 12 outlets.

The inlet 122 is configured to be fluidically connected, either directly or indirectly, to an upstream system 171 to receive a stream of fluid from the upstream system. The fluid can be any fluidic substances, including but not limited to those in the pharmaceutical, vaccine production, alternative protein, and biotechnology industries. In some embodiments, the fluid includes proteins, peptides, cells, nucleic acids, vaccines, diagnostics, reagents, raw materials, other macromolecules, or any combination thereof. In some embodiments, the fluid includes a biological component, such as a biopharmaceutical or vaccine product or an intermediate component of the biopharmaceutical or vaccine product.

Any outlet of the valve 120 is individually selectable for fluidically coupling with the inlet 122 of the valve 120. That is, individual outlets are fluidically separated from each other, and the inlet can be selectively coupled with any one of the individual outlets to form a flow path between the inlet and the selected individual outlet. For instance, the inlet can be selectively coupled with the outlet labeled “1” to form a flow path between the inlet and the outlet labeled “1”. Similarly, the inlet can be selectively coupled with the outlet labeled “2” to form a flow path between the inlet and the outlet labeled “2” or selectively coupled with the outlet labeled “3” to form a flow path between the inlet and the outlet labeled “3”. Examples of such a valve are disclosed in US 2022/0074533 A1 published Mar. 10, 2022, which is hereby incorporated by reference in its entirety.

The outlets or at least some of the outlets in the plurality of outlets are grouped into one or more outlet sets. Each outlet set in the one or more outlet sets may include a plurality of outlets, e.g., two, three, four, five, or more than five outlets. For instance, as a non-limiting example, in some embodiments, each outlet set includes a first outlet and a second outlet. In some embodiments, additionally or optionally, an outlet set includes a third outlet. For instance, as a non-limiting example, FIG. 1 illustrates the outlets labeled “1”, “2” and “3” grouped into an outlet set 130-1 and the outlets labeled “4”, “5” and “6” grouped into an outlet set 130-2. Each of the outlet sets 130-1 and 130-2 includes a first outlet 131, a second outlet 132, and a third outlet 133. In some embodiments, the third outlet 133 is configured to be fluidically connected, either directly or indirectly, to a downstream system 172 (e.g., a waste module, a waste collection or the like).

While FIG. 1 illustrates two outlet sets, it should be noted that a valve can consist of a single outlet, e.g., either the outlet set 130-1 or the outlet set 130-2. A valve can also include 3, 4, 5, 6, 7, 8, 9, 10, or more than 10 outlet sets. For instance, in some embodiments, the remaining outlets of the valve 120 in FIG. 1 are grouped to form one or more additional outlet sets. In addition, while FIG. 1 illustrates each of the outlet sets 130-1 and 130-2 includes a third outlet, it should be noted that an outlet set can, but do not necessarily have to, have a third outlet. For instance, in some embodiments, two outlets (e.g., the outlets labeled “1” and “2”, the outlets labeled “2” and “3”, or the outlet labeled “3” and “4”) may be grouped to form one outlet set.

The collection module 100 also includes one or more container sets to collect the fluid. For instance, in some embodiments, the collection module consists of a single container set, and in some other embodiments, the collection module includes a plurality of container sets (e.g., 2, 3, 4, 5, 6, 7, 8, 9, 10, or more than 10 container sets). As a non-limiting example, FIG. 1 illustrates the collection module including a container set 140-1 and a container set 140-2. Generally, the number of container sets does not exceed the number of outlet sets of the valve of the collection module. For instance, in some embodiments, the number of the one or more container sets is the same as the number of the one or more outlet sets of the valve, e.g., having the same number of sets. In some embodiments, the number of the one or more container sets is less than the number of the one or more outlet sets of the valve, e.g., the valve having a greater number of outlet sets than the one or more container sets. In some such embodiments, one or more outlets of the valve may not be connected to any container, or may be connected to other component(s) rather than a container.

Each container set in the one or more container sets may include a plurality of containers, e.g., two, three, four, five, or more than five containers. For instance, as a non-limiting example, in some embodiments, each container set in the one or more container sets includes a first container 141 and a second container 142. In some embodiments, each container set in the one or more container sets includes the first container 141, the second container 142, and one or more additional containers. The first and second containers of a respective container set in the one or more container sets are fluidically connected to the first and second outlets of a corresponding outlet set in the one or more outlet sets of the valve. For instance, in the illustrated embodiment, the first container 141 of the container set 140-1 is fluidically connected to the first outlet 131 of the outlet set 130-1 and the second container 142 of the container set 140-1 is fluidically connected to the second outlet 132 of the outlet set 130-1. Similarly, the first container 141 of the container set 140-2 is fluidically connected to the first outlet 131 of the outlet set 130-2 and the second container 142 of the container set 140-2 is fluidically connected to the second outlet 132 of the outlet set 130-2.

A container is configured to collect a certain amount of the fluid. For instance, in some embodiments, the first container 141 is configured to collect a first amount of the fluid and the second container 142 is configured to collect a second amount of the fluid. In some embodiments, the first or second amount is collected for sample testing. For instance, in an embodiment, one of the first and second containers is configured to collect a bulk amount of the fluid whereas the other of the first and second containers is configured to collect a smaller amount of the fluid for sample testing.

A container can be made of any suitable material compatible with the fluid to be collected and in any suitable shape or size. For instance, a container may be made of plastics or glass and may take the shape of a bag, a bottle, a carboy, or other collection vessels. A container can be a single-use, disposable, or reusable container.

The first and second containers of a respective container set in the one or more container sets can have the same configuration or different configurations, e.g., having the same or different shape/size or made of the same or different material. For instance, the first container 141 of the container set 140-1 can have a configuration the same as or different from that of the second container 142 of the container set 140-1. In embodiments where the collection module includes multiple container sets, the first containers of different container sets can have the same configuration or different configurations. For instance, the first container 141 of the container set 140-1 can have a configuration the same as or different from that of the first container 141 of the container set 140-2. Similarly, the second containers of different container sets can have the same configuration or different configurations. For instance, the second container 142 of the container set 140-1 can have a configuration the same as or different from that of the second container 142 of the container set 140-2.

In some embodiments, the collection module 100 includes one or more additional or optional components, such as one or more filters 151, one or more disconnection devices 152, one or more sensors 153 or any combination thereof. For instance, in some embodiments, the collection module includes a filter and/or a disconnection device, and the first or second container of a container set is fluidically connected to the first or second outlet of a corresponding outlet set of the valve through the filter and/or disconnection device. In some embodiments, the collection module includes a sensor positioned and configured to monitor or measure an amount of the fluid (e.g., weight, volume, fluid level or the like) in the first or second container of a container set, a sensor positioned and configured to monitor or measure a temperature of the collection module or the space where the collection module is located, or any combination thereof.

By way of example, FIG. 1 illustrates the collection module including a plurality of filters 151, a plurality of disconnection device 152, and one or more sensors 153. Each of the first and second containers of the container sets 140-1 and 140-2 is fluidically connected to the corresponding first or second outlet of the outlet sets 130-1 and 130-2 through a filter and a disconnection device. In some embodiments, the filter is a sterile filter and serves as a final barrier to ensure the fluid to be collected is of high quality. In some embodiments, the disconnection device is an aseptic disconnection device that allows disconnection of the first or second container from the collection module without compromising the sterile barrier. In some embodiments, the one or more sensors 153 includes at least one sensor positioned and configured to monitor or measure an amount of the fluid in the first and/or second container of at least one container set. In some embodiments, the one or more sensors 153 includes a plurality of sensors each positioned and configured to monitor or measure an amount of the fluid in the first and/or second container of a container set.

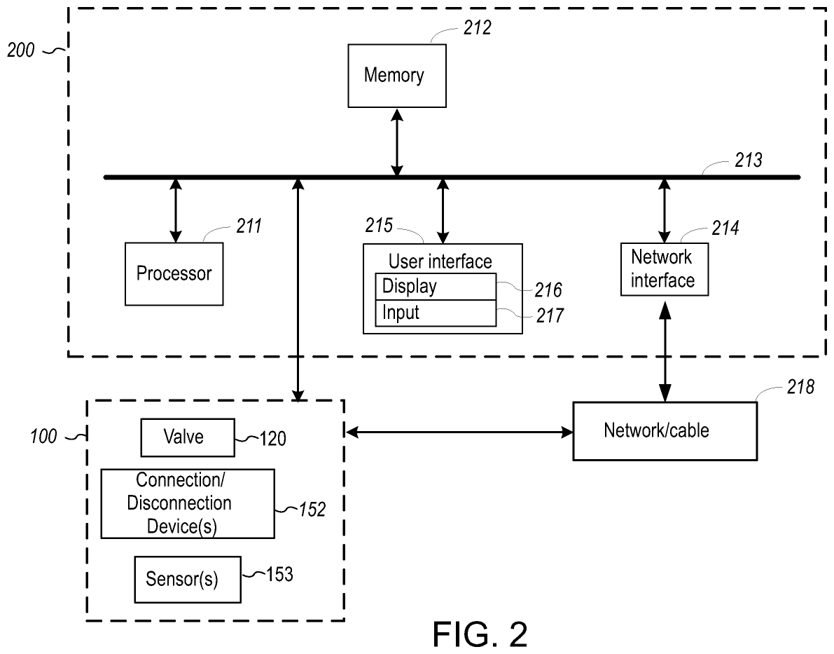

FIG. 2 illustrates an exemplary control unit, generally designated 200, in accordance with some exemplary embodiments of the present invention. The control unit 200 is configured to control the operation of the collection module 100 through the valve 120, and in some cases, along with other components such as the disconnection device 152 and/or sensor 153. The control unit 200 includes one or more processors 211, a memory 212, and one or more communication busses 213 interconnecting the processor(s) and memory. The memory stores one or more programs configured to be executed by the one or more processors. The memory 212 may include random access memory, such as RAM, DRAM, SRAM, DDR RAM, or other random access solid state memory devices, and optionally may also include non-volatile memory, such as one or more magnetic disk storage devices, optical disk storage devices, flash memory devices, or other non-volatile solid state storage devices. The memory 212 may optionally include one or more storage devices remotely located from the processor(s) 211. The memory 212, or alternatively the non-volatile memory device(s) within memory 212, may include a non-transitory computer readable storage medium. In some embodiments, the memory 212 may include mass storage that is remotely located with respect to the processor(s) 211. In other words, some data stored in memory 212 may in fact be hosted on devices that are external to the control unit 200, but that can be electronically accessed by the control unit 200 over a network/cable 218 (e.g., an Internet, intranet, electronic cable or the like) using a communication interface 214.

In some embodiments, additionally or optionally, the control unit 200 may include a user interface 215. The user interface 215 typically includes a display device 216 for presenting data, receiving instructions (e.g., the display device including a touch-sensitive surface), or both. In some embodiments, the user interface 215 includes an optional input device 217, such as a keyboard, a mouse or the like, for receiving instructions. The user interface 215 may be an integral part of the control unit 200. Alternatively, the user interface 215 may be a part external to the control unit 200 but can be accessed by the control unit 200 over the network/cable 218 using the communication interface 214.

The control unit 200 may be electrically connected to the valve 120, device 152 and/or sensor 153 through the one or more communication busses 213, through the communication interface 214 and the network/cable 218, or both. For instance, in an embodiment, the control unit 200 is electrically connected to each of the valve 120, device 152 and/or sensor 153 through the one or more communication busses 213. In another embodiment, the control unit 200 is electrically connected to each of the valve 120, device 152 and/or sensor 153 through the communication interface 214 and the network/cable 218. In a further embodiment, the control unit 200 is electrically connected to at least one of the valve 120, device 152 and/or sensor 153 through the one or more communication busses 213 and to at least one of the valve 120, device 152 and/or sensor 153 through the communication interface 214 and the network/cable 218.

The control unit 200 is configured to control the operation of the valve 120 to alternately couple the first outlet and the second outlet of an outlet set with the inlet (e.g., toggling back and forth) a plurality of times, allowing the first container and the second container of a container set to alternately collect the fluid. For instance, in some embodiments, under the control of the control unit 200, the first outlet 131 and the second outlet 132 of the outlet set 130-1 are alternately coupled with the inlet 122 for a plurality of times, allowing the first container 141 and the second container 142 of the container set 140-1 to alternately collect the fluid. As such, the fluid collected in the first container and the fluid collected in the second container are true representative of each other. In embodiments where one of the first and second containers is configured to collect a bulk amount of the fluid whereas the other of the first and second containers is configured to collect a smaller amount of the fluid for sample testing, this ensures collection of a representative sample for quality control testing without compromising the sterile integrity of the bulk material. For instance, in some embodiments, the first container 141 of the container set 140-1 is configured to collect a smaller amount of the fluid for sample testing and the second container 142 of the container set 140-1 is configured to collect a bulk amount of the fluid. This ensures that the fluid collected in the first container 141 is a true representative sample of the fluid collected in the second container 142 of the container set 140-1 without compromising its sterile integrity.

Depending on the application (e.g., the fluid to be collected, the size of containers) and/or preference, the coupling of the first outlet and the second outlet of an outlet set with the inlet can alternate any suitable number of times. For instance, in some embodiments, the coupling of the first outlet 131 and the second outlet 132 of the outlet set 130-1 with the inlet 122 alternates at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, at least 100 times, at least 150 times, or at least 200 times.

In some embodiments, at a respective alternation, the coupling of the first outlet 131 of a respective outlet set (e.g., the outlet set 130-1) with the inlet 122 lasts for a first period of time and the coupling of the second outlet 132 of the respective outlet set with the inlet lasts for a second period of time. The first period of time may be determined based at least in part on (i) a total amount of fluid to be collected by the first container of the corresponding container set, (ii) a current amount of fluid in the first container of the corresponding container set, (iii) a rate of filling the first container of the corresponding container set, or any combination thereof. The second period of time may be determined based at least in part on (i) a total amount of fluid to be collected by the second container of the corresponding container set, (ii) a current amount of fluid in the second container of the corresponding container set, (iii) a rate of filling the second container of the corresponding container set, or any combination thereof.

The current amount of fluid in the first or second container of the corresponding container set may be measured by the sensor(s) 153 and monitored by the control unit 200. In some embodiments, based at least in part on the measurement data from the sensor(s), the control unit 200 determines or alters the first period of time, the second period of time, the number of times that the first and second outlets are alternately coupled with the inlet, or any combination thereof. In some embodiments, the control unit obtains measurement data from the sensor(s) at a rate of every 60 seconds or less, every 50 seconds or less, every 40 seconds or less, every 30 seconds or less, every 25 seconds or less, every 20 seconds or less, every 15 seconds or less, every 10 seconds or less, every 5 seconds or less, every 4 seconds or less, every 3 seconds or less, every 2 seconds or less, or every 1 second or less. The rate to obtain measurement data may be constant or varied during the process.

In some embodiments, the collection module includes a plurality of container sets each fluidically connected to a corresponding outlet set of the valve. The control unit is configured to control the operation of the valve to alternately couple the inlet with the first and second outlets of one outlet set for a first plurality of times and then alternately coupling the inlet with the first and second outlets of another outlet set for a second plurality of times. In other words, the inlet is coupled with the outlet sets in a sequential manner (e.g., one outlet set at a time), where within each respective outlet set, the inlet is alternately coupled with the first and second outlets (e.g., toggled back and forth between the first and second outlets of the respective outlet set). For instance, under the control of the control unit 200, the inlet 122 is first coupled with the outlet set 130-1. Within the outlet set 130-1, the inlet 122 is alternately coupled with the first outlet 131 and the second outlet 132 of the outlet set 130-1 for a first plurality of times, thereby allowing the first and second containers of the container set 140-1 to alternately collect the fluid. After the first and second containers of the container set 140-1 are filled with desired amounts of the fluid, the inlet 122 is then coupled with the outlet set 130-2. Within the outlet set 130-2, the inlet 122 is alternately coupled with the first outlet 131 and the second outlet 132 of the outlet set 130-2 for a second plurality of times. The coupling of the inlet 122 with the first and second outlets of the outlet set 130-2 can alternate any suitable number of times, which can be, but do not necessarily have to be the same number of times as the coupling of the first and second outlets of the outlet set 130-1 with the inlet. For instance, the coupling of the first and second outlets of the outlet set 130-2 with the inlet can alternate at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, or at least 100 times.

In some embodiments, a respective outlet set includes a third outlet fluidically connected to a downstream system. The control unit is configured to control the valve to couple the inlet with the third outlet of the respective outlet set, and thus allow flushing (e.g., priming, preconditioning) the valve and/or other components (e.g., conduit) of the collection module with the fluid from the upstream system or other fluid(s) to the downstream system. The coupling of the inlet with the third outlet of the respective outlet set can last for any suitable time period, e.g., as long as it takes to properly flush the valve or other component(s) of the collection module, and may vary during the process. The coupling of the inlet with the third outlet is typically performed prior to alternately coupling the inlet with the first and second outlets of the respective outlet set. This reduces potential contamination from any prior process.

For instance, in some embodiments, the outlet set 130-1 includes a third outlet 133 fluidically connected to the downstream system 172. The control unit is configured to control the valve to couple the inlet 122 with the third outlet 133 of the outlet set 130-1 and thus allow flushing the valve and/or other components of the collection module. The coupling of the inlet with the third outlet of the outlet set 130-1 is typically performed prior to alternately coupling the inlet with the first outlet and the second outlet of the outlet set 130-1. This reduces potential contamination from any prior process that uses the valve. In some embodiments, the outlet set 130-2 also includes a third outlet 133 fluidically connected to the downstream system 172. The control unit is configured to control the valve to couple the inlet 122 with the third outlet 133 of the outlet set 130-2 and thus allow flushing the valve and/or other components of the collection module. The coupling of the inlet with the third outlet of the outlet set 130-2 is typically performed subsequent to alternately coupling the inlet with the first outlet and the second outlet of the outlet set 130-1 but prior to alternately coupling the inlet with the first outlet and the second outlet of the outlet set 130-2. This reduces potential contamination from any prior process including the coupling of the inlet with the outlet set 130-1 and collection of the fluid by the container set 140-1.

In some embodiments, the inlet is prohibited from going backward to couple with any prior outlet set after the first and second containers of the corresponding container set have been filled or partially filled with the fluid. This reduces potential cross contamination among different outlet sets, different container sets and/or the fluid collected in different containers. For instance, in some embodiments, the inlet is being coupled with the outlet set 130-2 after the outlet set 130-1. The inlet is prohibited from going backward to couple again with the outlet set 130-1. This prevents cross contamination among the outlet set 130-1, the outlet set 130-2, the container set 140-1, the container set 140-2, the fluid collected by the first and second containers of the container set 140-1 and the fluid collected by the first and second containers of the container set 140-2.

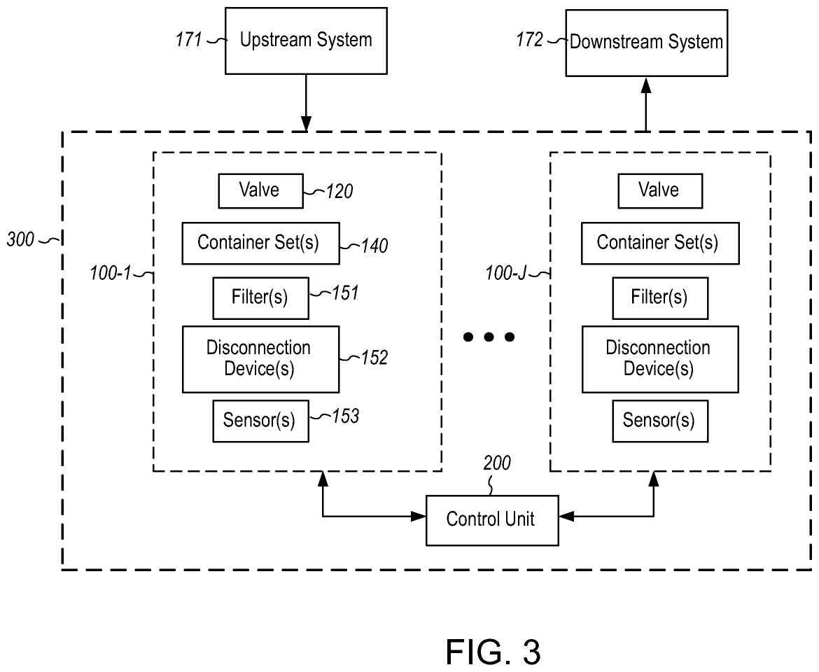

FIG. 3 illustrates an exemplary system, generally designated 300, in accordance with some exemplary embodiments of the present invention. The system 300 includes one or more collection modules 100-j (j=1, . . . J) and the control unit 200. Each of the one or more collection modules includes a value 120, one or more container sets 140, and in some cases, one or more additional or optional components such as the filter(s) 151, disconnection device(s) 152 and/or sensor(s) 153. The control unit 200 is electrically configured to control the operation of the one or more collection modules. For instance, the control unit 200 is electrically connected to the valve of each collection module in the one or more collection modules and configured to control the operation of the valve of each collection module in the one or more collection modules.

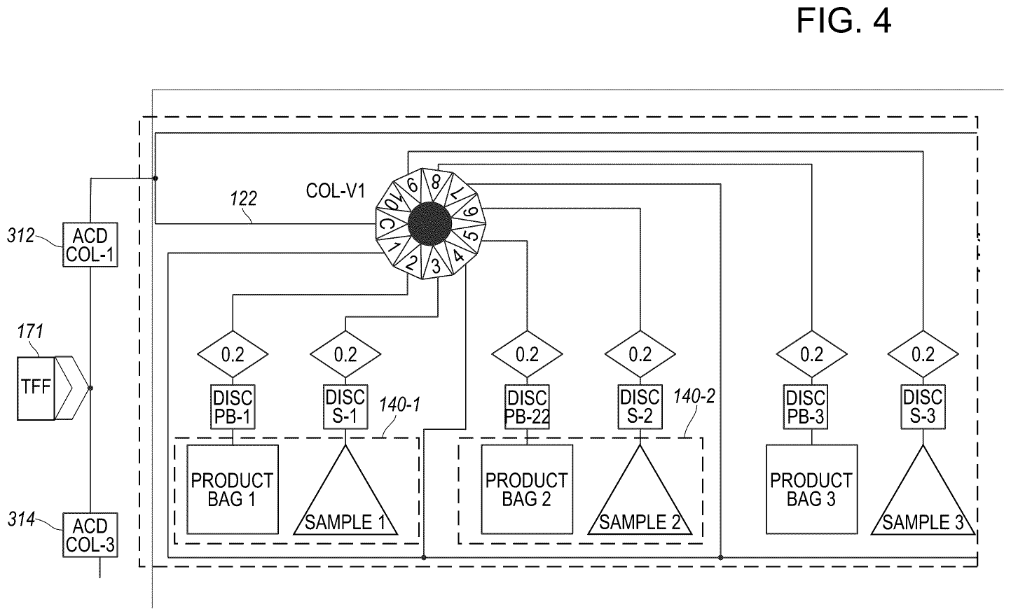

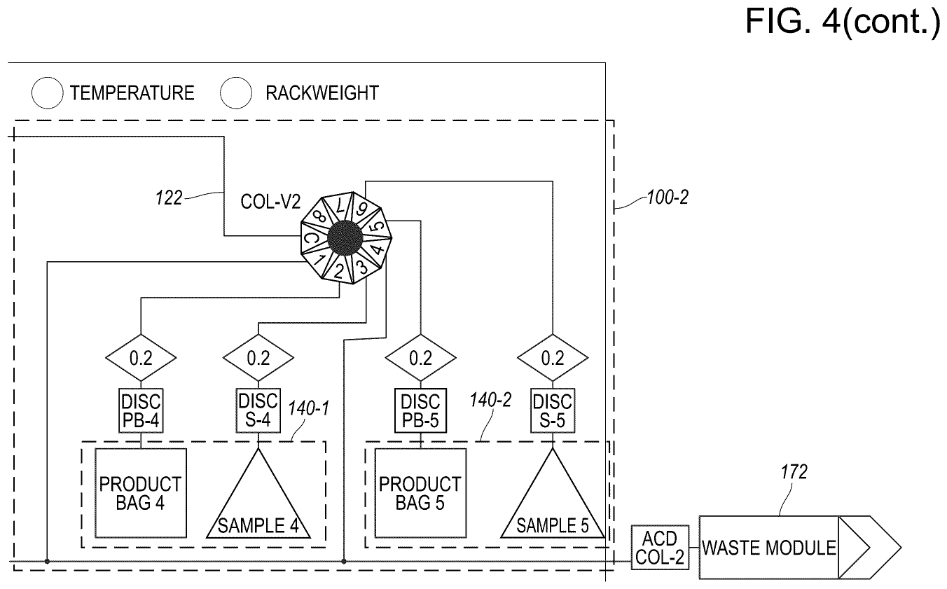

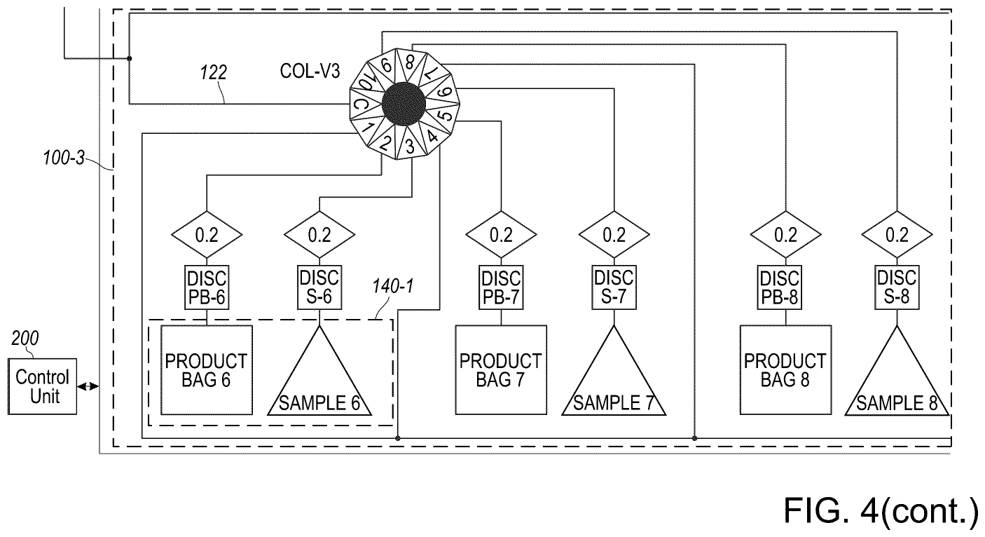

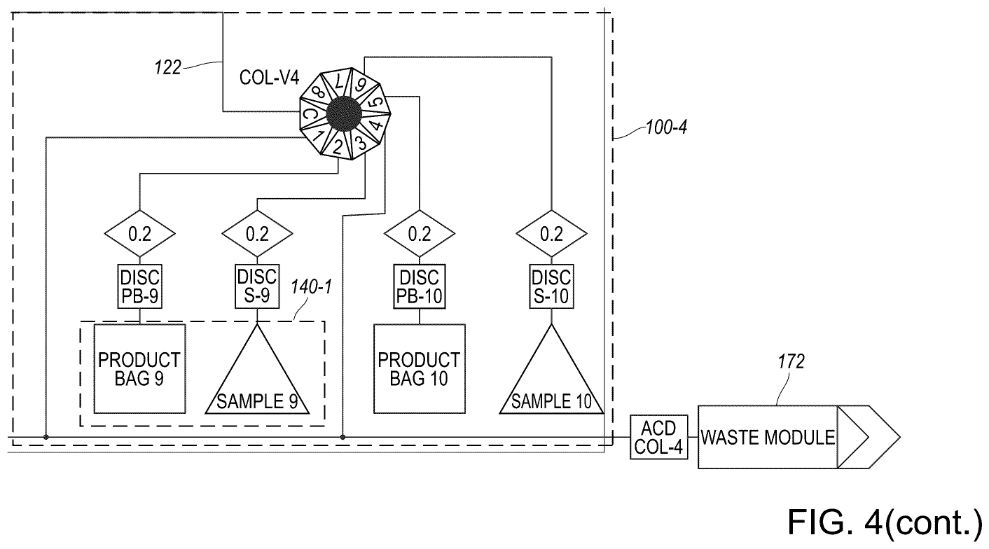

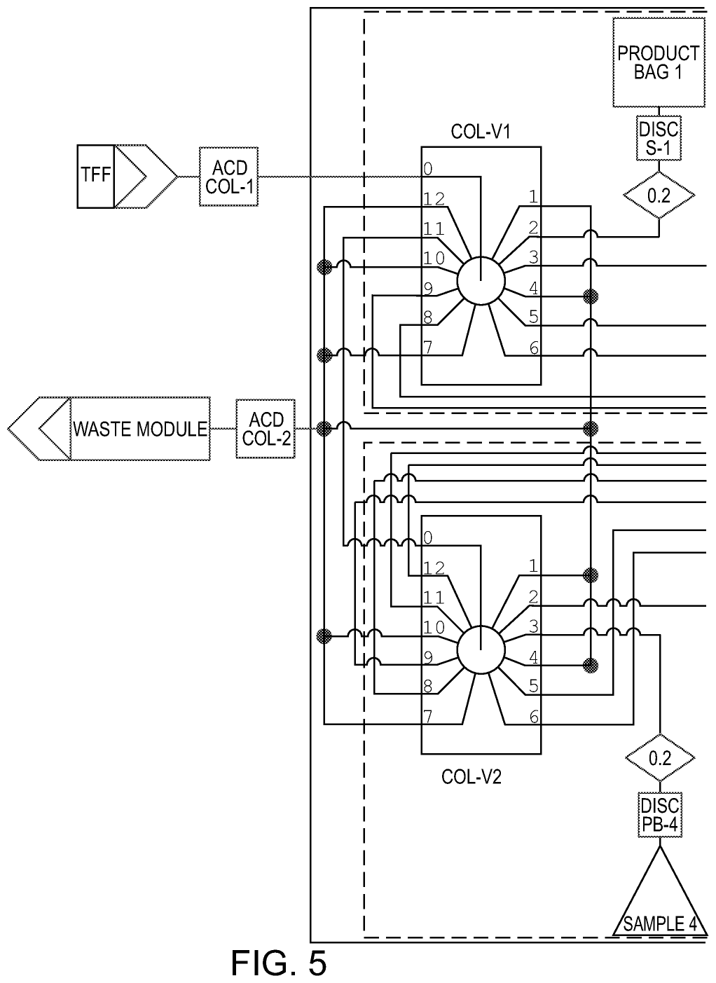

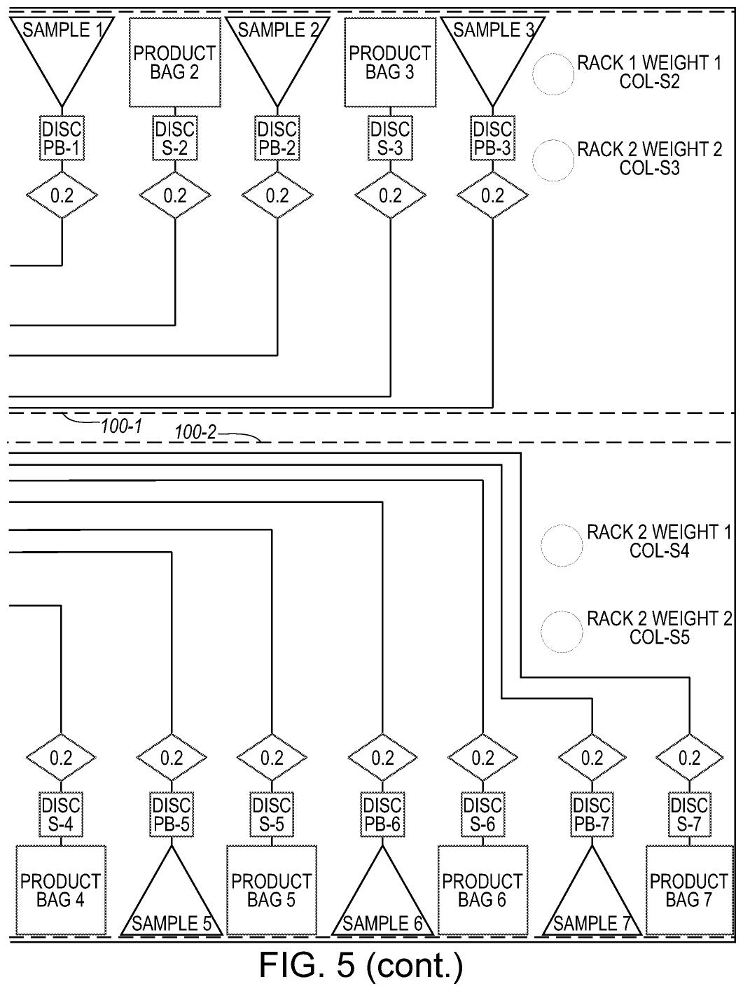

The system can include any number of collection modules. For instance, in some embodiments, the system consists of a single collection module, e.g., the collection module 100 illustrated in FIG. 1 itself is a collection system. In some other embodiments, the system includes a plurality of collection modules, e.g., 2, 3, 4, 5, 6, 7, 8, 9, 10, or more than 10 collection modules. As a non-limiting example, FIG. 4 illustrates a system with 4 collection modules, e.g., the collection modules 100-1, 100-2, 100-3 and 100-4. As another non-limiting example, FIG. 5 illustrates a system with 2 collection modules, e.g., the collection modules 100-1 and 100-2.

In embodiments where the system includes a plurality of collection modules, any two collection modules can be configured the same as each other or different from each other. For instance, in an embodiment, collection modules in the plurality of collection modules are identical, e.g., each collection module having an identical valve (e.g., same shape, same size, made of same material, same number of outlets, and same arrangement of the outlets), identical container set(s), and if present, identical additional or optional component(s). In some embodiments, at least two collection modules in the plurality of collections are configured differently. The difference may be in the configuration of the valve (e.g., shape, size, material, the number of outlets, the way how the outlets are grouped), the number of container sets, the configuration of each container, the use of additional or optional component(s), or any combination thereof. For instance, as a non-limiting example, FIG. 4 illustrates the valve of a collection module (e.g., the collection module 100-2) has a number of outlet (e.g., 8 outlets) different than that of the valve of another collection module (e.g., the valve of the collection module 100-1 having 10 outlets). FIG. 4 also illustrates a collection module (e.g., the collection module 100-2) includes a number of container sets (e.g., 2 container sets) different than that of another collection module (e.g., the collection module 100-1 having 3 container sets).

In some embodiments, the one or more collection modules include a first collection module (e.g., the collection module 100 in FIG. 1, the collection module 100-1 in FIG. 3, the collection module 100-1 in FIG. 4, or the collection module 100-1 in FIG. 5). For the first collection module, the inlet 122 of the valve is configured to be fluidically connected to an upstream system (e.g., the upstream system 172) to receive a first stream of fluid from the upstream system. The one or more outlet sets of the valve include a first outlet set (e.g., the outlet set 130-1) and the one or more container sets include a first container set (e.g., the container set 140-1). The first container (e.g., the first container 141) of the first container set is fluidically connected to the first outlet (e.g., the first outlet 131) of the first outlet set, and the second container (e.g., the second container 142) of the first container set is fluidically connected to the second outlet (e.g., the second outlet 132) of the first outlet set. The control unit controls the operation of the valve to alternately couple the first outlet and the second outlet of the first outlet set with the inlet a first plurality of times, allowing the first container and the second container of the first container set to alternately collect the first stream of fluid.

In some embodiments, for the first collection module in the one or more collection modules, the coupling of the first outlet and the second outlet of the first outlet set with the inlet alternates at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, or at least 100 times. In some embodiments, the coupling of the first outlet and the second outlet of the first outlet set with the inlet alternates between 5 and 20 times, between 10 and 25 times, between 15 and 30 times, between 20 and 35 times, between 25 and 40 times, between 30 and 45 times, between 35 and 50 times, or between 50 and 100 times.

In some embodiments, for the first collection module in the one or more collection modules and at a respective alternation, the coupling of the first outlet of the first outlet set with the inlet lasts for a first period of time and the coupling of the second outlet of the first outlet set with the inlet lasts for a second period of time. In some embodiments, the first period of time is determined based at least in part on (i) a total amount of fluid to be collected by the first container of the first container set, (ii) a current amount of fluid in the first container of the first container set, (iii) a rate of filling the first container of the first container set, or any combination thereof; and the second period of time is determined based at least in part on (i) a total amount of fluid to be collected by the second container of the first container set, (ii) a current amount of fluid in the second container of the first container set, (iii) a rate of filling the second container of the first container set, or any combination thereof.

In some embodiments, for the first collection module in the one or more collection modules: the first outlet set further includes a third outlet (e.g., the third outlet 133) fluidically connected to a downstream system (e.g., the downstream 172). The control units is configured to control the operation of the volve to couple, prior to alternately coupling the first outlet and the second outlet of the first outlet set with the inlet, the third outlet of the first outlet set with the inlet, and thus allow flushing the valve with the first stream of fluid.

In some embodiments, for the first collection module in the one or more collection modules, the one or more outlet sets of the valve further include a second outlet set (e.g., the second outlet set 130-2). The one or more container sets further include a second container set (e.g., the second container set 140-2). The first container (e.g., the first container 141) of the second container set is fluidically connected to the first outlet of the second outlet set, and the second container (e.g., the container 142) of the second container set is fluidically connected to the second outlet of the first outlet set. The control unit is configured to control the operation of the valve to alternately couple the first outlet and second outlet of the second outlet set with the inlet a second plurality of times, allowing the first container and second container of the second container set to alternately collect the first stream of fluid. The coupling of the first outlet and second outlet of the second outlet set with the inlet is performed subsequent to alternately coupling the first outlet and the second outlet of the first outlet set with the inlet.

In some embodiments, for the first collection module in the one or more collection modules, the coupling of the first and second outlets of the second outlet set with the inlet alternates at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, or at least 100 times. In some embodiments, the coupling of the first outlet and the second outlet of the second outlet set with the inlet alternates between 5 and 20 times, between 10 and 25 times, between 15 and 30 times, between 20 and 35 times, between 25 and 40 times, between 30 and 45 times, or between 35 and 50 times.

In some embodiments, for the first collection module in the one or more collection modules, the second outlet set further includes a third outlet (e.g., the third outlet 133) fluidically connected to a downstream system (e.g., the downstream system 172). The control unit is configured to couple the third outlet of the second outlet set with the inlet and thus flushing the valve with the first stream of fluid. The coupling of the third outlet of the second outlet set with the inlet is performed subsequent to alternately coupling the first outlet and the second outlet of the first outlet set with the inlet but prior to alternately coupling the first outlet and the second outlet of the second outlet set with the inlet.

In some embodiments, the one or more collection modules further includes a second collection module (e.g., the collection module 100-2 in FIG. 3, the collection module 100-2 in FIG. 4, the collection module 100-3 in FIG. 4, the collection module 100-4 in FIG. 4, or the collection module 100-2 in FIG. 5). The one or more outlet sets of the valve of the second collection module can have a same number of sets as the one or more outlet sets of the valve of the first collection module, or a different number of sets than the one or more outlet sets of the valve of the first collection module. For instance, as a non-limiting example, FIG. 4 illustrates that the valve of the collection module 100-1 (the first collection module) has 3 outlet sets. The valve of the collection module 100-3 has the same number of outlet sets (e.g., 3 outlet sets) as the valve of the collection module 100-1 whereas the valve of the collection module 100-2 has a different number of outlet sets (e.g., 2 outlet sets) than the valve of the collection module 100-1. FIG. 5 illustrates that the valve of the collection module 100-1 (the first collection module) has 3 outlet sets whereas the valve of the collection module 100-2 has a different number of outlet sets (e.g., 4 outlet sets) than the valve of the collection module 100-1.

Similarly, the one or more container sets of the second collection module can have a same number of sets as the one or more container sets of the first collection module or a different number of sets than the one or more container sets of the first collection module. For instance, as a non-limiting example, FIG. 4 illustrates that the collection module 100-1 (the first collection module) has 3 container sets. The collection module 100-3 has the same number of container sets (e.g., 3 container sets) as the collection module 100-1 whereas the collection module 100-2 has a different number of container sets (e.g., 2 container sets) than the collection module 100-1. FIG. 5 illustrates that the collection module 100-1 (the first collection module) has 3 container sets whereas the collection module 100-2 has a different number of container sets (e.g., 4 outlet sets) than the collection module 100-1.

The inlet of the valve of the second collection module is configured to be fluidically connected to the upstream system to receive a stream of the fluid from the upstream system. The inlet of the valve of the second collection module can receive a stream of the fluid from the upstream system in a variety of ways. For instance, in some embodiments, the inlet of the valve of the second collection module is configured to receive a stream of the fluid from the upstream system through a common upstream connector as the inlet of the valve of the first collection module, through a different upstream connector, or through the valve of the first collection module.

As a non-limiting example, FIG. 4 illustrates that the inlet of the valve of the collection module 140-1 (the first collection module) is fluidically connected to the upstream system through an upstream connector 312. The inlet of the valve of the collection module 140-2 is fluidically connected to the upstream system through the upstream connector 312 as the inlet of the valve of the first collection module, whereas the inlet of the valve of the collection module 100-3 or 100-4 is fluidically connected to the upstream system through a different upstream connector 314. In some embodiments, the upstream connector 312 or 314 is an aseptic connection device. In these embodiments, the valve of the first collection module and the valve of the second collection module can be controlled independently and separately. For instance, the valve of the first collection module and the valve of the second collection module can be controlled to operate concurrently, subsequently, or overlapped.

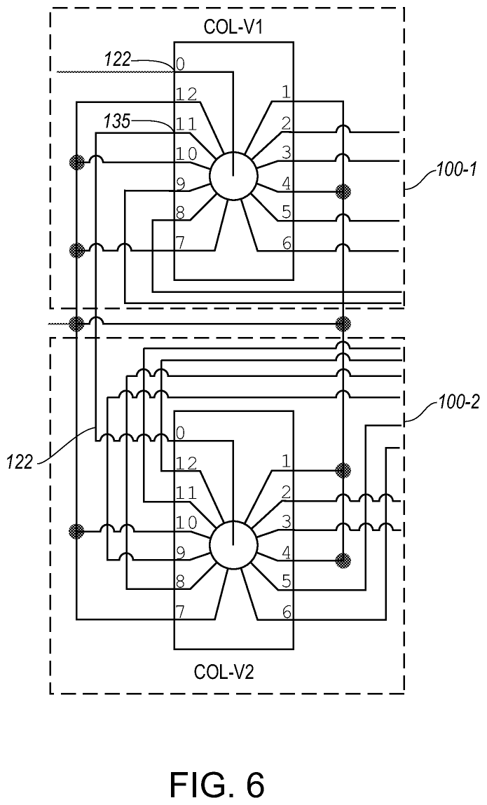

As another non-limiting example, FIGS. 5 and 6 illustrate the inlet of the valve of the second collection module configured to receive a stream of the fluid from the upstream system through the valve of the first collection module. In the illustrated embodiment, the valve 120 of the first collection module (the collection module 100-1) includes an outlet 135 (i.e., the outlet labeled “11”) to serve as a transfer outlet. The inlet 122 of the valve of the second connection module (the connection module 100-2) is fluidically connected to the transfer outlet of the valve of the first collection module and thus is able to receive a stream of the fluid through the valve of the connection module 100-1. When it is desired for the second module to collect the fluid, the control unit controls the operation of the valve of the first collection module to couple the transfer outlet 135 with the inlet 122 of the valve of the first connection module, allowing the fluid to flow from the transfer outlet 135 to the inlet 122 of the valve of the second connection module.

In some embodiments, for the second collection module in the one or more collection modules, the one or more outlet sets of the valve include a first outlet set (e.g., outlet set 130-1), and the one or more container sets include a first container set (e.g., the container set 140-1). The first container of the first container set is fluidically connected to the first outlet of the first outlet set, and the second container of the first container set is fluidically connected to the second outlet of the first outlet set. The control unit is configured to control the operation of the valve of the second collection module to alternately couple the first outlet and the second outlet of the first outlet set with the inlet a third plurality of times, allowing the first container and the second container of the first container set of the second collection module to alternately collect the fluid.

In some embodiments, for the second collection module in the one or more collection modules, the first outlet set further includes a third outlet (e.g., the third outlet 133) fluidically connected to a downstream system (e.g., the downstream system 172). The control unit is configured to control the operation of the valve to couple the third outlet of the first outlet set with the inlet and thus allow flushing the valve of the second collection module with the second stream of fluid. The coupling of the third outlet of the first outlet set with the inlet is performed prior to alternately coupling the first outlet and the second outlet of the first outlet set with the inlet.

In some embodiments, for the second collection module in the one or more collection modules, the one or more outlet sets further include a second outlet set (e.g., the outlet set 130-2) and the one or more container sets further include a second container set (e.g., the container set 140-2). The first container of the second container set is fluidically connected to the first outlet of the second outlet set, and the second container of the second container set is fluidically connected to the second outlet of the first outlet set. The control unit is configured to control the operation of the valve of the second collection module to alternately couple the first outlet and second outlet of the second outlet set with the inlet a fourth plurality of times, allowing the first container and second container of the second container set of the second collection module to alternately collect the fluid. The coupling of the first outlet and second outlet of the second outlet set with the inlet is performed subsequent to alternately coupling the first outlet and the second outlet of the first outlet set with the inlet.

In some embodiments, for the second collection module in the one or more collection modules, the second outlet set further includes a third outlet (e.g., the third outlet 133) fluidically connected to a downstream system (e.g., the downstream system 172). The control unit is configured to control the operation of the valve to couple the third outlet of the second outlet set with the inlet and thus allow flushing the valve of the second collection module with the fluid. The coupling of the third outlet of the second outlet set with the inlet is performed subsequent to alternately coupling the first outlet and the second outlet of the first outlet set with the inlet but prior to alternately coupling the first outlet and the second outlet of the second outlet set with the inlet.

The coupling of the inlet with the first and second outlets of an outlet set in the second collection module can alternate the same number of times as the coupling of the inlet with the first and second outlets of an outlet set in the first collection module, or alternate a different number of times than the coupling of the inlet with the first and second outlets of an outlet set in the first collection module. For instance, in some embodiments, the coupling of the inlet with the first and second outlets of the first outlet set in the second module alternates the same number of times as the coupling of the inlet with the first and second outlets of the first outlet set in the first collection module, i.e., the third plurality of times is the same as the first plurality of times. In some embodiments, the coupling of the inlet with the first and second outlets of the first outlet set in the second module alternates a different number of times that the coupling of the inlet with the first and second outlets of the first outlet set in the first collection module, i.e., the third plurality of times is different than the first plurality of times.

In some embodiments, the one or more collection modules further includes a third collection module (e.g., the collection module 100-3 in FIG. 3). The one or more outlet sets of the valve of the third collection module can have a same number of sets as the one or more outlet sets of the valve of the first or second collection module, or a different number of sets than the one or more outlet sets of the valve of the first or second collection module. Similarly, the one or more container sets of the third collection module can have a same number of sets as the one or more container sets of the first or second collection module or a different number of sets than the one or more container sets of the first or second collection module.

Like that of the second collection module, the inlet of the valve of the third collection module can receive a stream of the fluid from the upstream system in a variety of ways. For instance, in some embodiments, the inlet of the valve of the third collection module can be configured to be fluidically connected to the upstream system to receive a stream of the fluid from the upstream system through a common upstream connector as the inlet of the valve of the first collection module, through a common upstream connector as the inlet of the valve of the second collection module, through a different upstream connector, through the valve of the first collection module, or through the valve of the second collection module. The fluidic connection of the inlet of the third collection module can be done in a manner similar to those disclosed herein with respect to the second collection module.

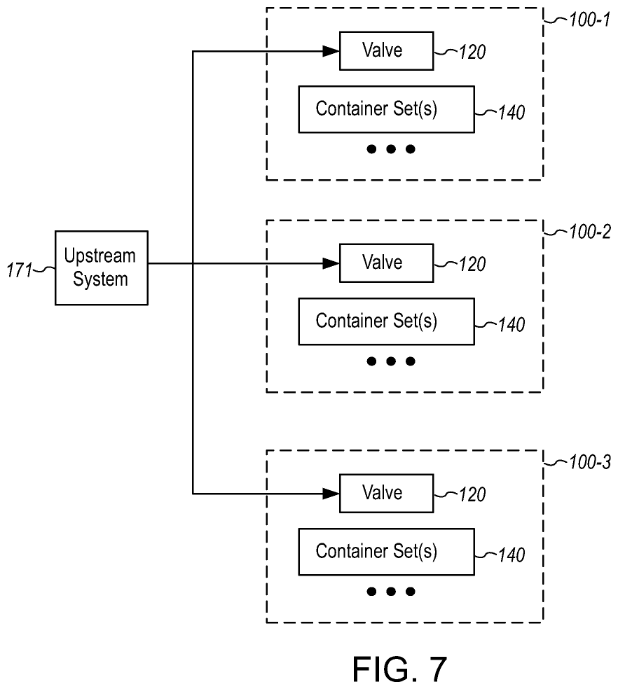

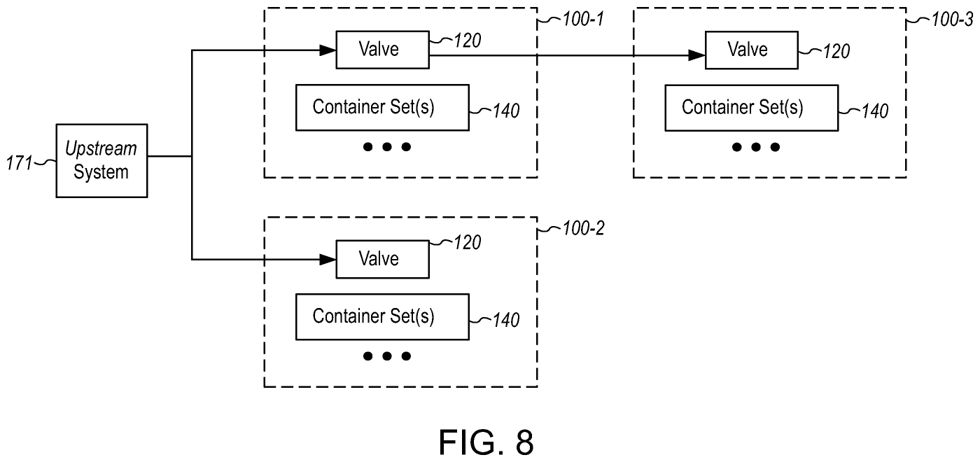

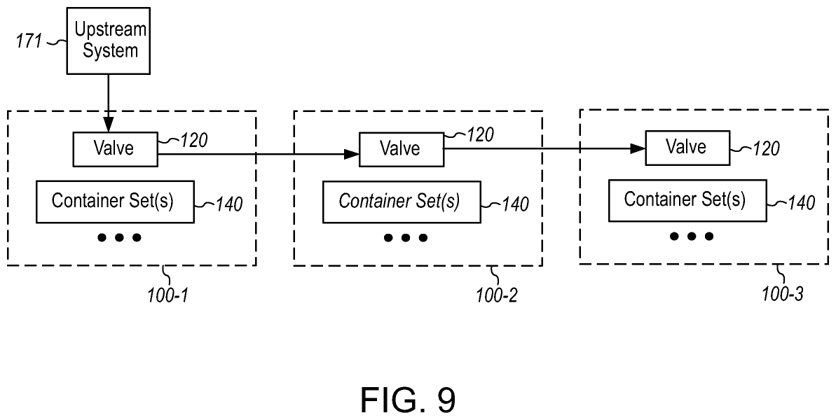

For instance, as a non-limiting example, FIG. 7 illustrates that the inlets of the valves of the collection modules 100-1, 100-2 and 100-3 are fluidically connected to the upstream system, and none of which is through a valve of a collection module. As another non-limiting embodiment, FIG. 8 illustrates that the inlet of the valve of the collection module 100-3 is fluidically connected to the upstream system through the valve of the collection module 100-1. As a further non-limiting example, FIG. 9 illustrate that the inlet of the valve of the collection module 100-2 is fluidically connected to the upstream system through the valve of the collection module 100-1, and the inlet of the valve of the collection module 100-3 is fluidically connected to the upstream system through the valve of the collection module 100-2.

In embodiments where the inlet of the valve of the third collection module is not configured to receive a stream of the fluid through the valve of the first collection module, the valve of the third connection module and the valve of the first connection module can be controlled independently. Similarly, in embodiments where the inlet of the valve of the third collection module is not configured to receive a stream of the fluid through the valve of the second collection module, the valve of the third connection module and the valve of the second connection module can be controlled independently.

In some embodiments, for the third collection module in the one or more collection modules, the inlet of the valve is configured to be fluidically connected to the upstream system to receive a third stream of fluid from the upstream system. The one or more outlet sets include a first outlet set (e.g., the outlet set 130-1), and the one or more container sets include a first container set (e.g., the container set 140-1). The first container of the first container set is fluidically connected to the first outlet of the first outlet set, and the second container of the first container set is fluidically connected to the second outlet of the first outlet set. The control unit is configured to control the operation of the valve of the third collection module to alternately couple the first outlet and the second outlet of the first outlet set with the inlet a plurality of times, allowing the first container and the second container of the first container set of the third collection module to alternately collect the fluid.

In some embodiments, for the third collection module in the one or more collection modules, the first outlet set further includes a third outlet (e.g., the third outlet 133) fluidically connected to a downstream system (e.g., the downstream system 172). The control unit is configured to control the operation of the valve to couple the third outlet of the first outlet set with the inlet and thus allow flushing the valve of the third collection module with a stream of the fluid. The coupling of the third outlet of the first outlet set with the inlet is performed prior to alternately coupling the first outlet and the second outlet of the first outlet set with the inlet.

In some embodiments, for the third collection module in the one or more collection modules, the one or more outlet sets further include a second outlet set (e.g., the outlet set 130-2) and the one or more container sets further include a second container set (e.g., the container set 140-2). The first container of the second container set is fluidically connected to the first outlet of the second outlet set, and the second container of the second container set is fluidically connected to the second outlet of the first outlet set. The control unit is configured to control the operation of the valve of the third collection module to alternately couple the first outlet and second outlet of the second outlet set with the inlet a plurality of times, allowing the first container and second container of the second container set of the third collection module to alternately collect the fluid. The coupling of the first outlet and second outlet of the second outlet set with the inlet is performed subsequent to alternately coupling the first outlet and the second outlet of the first outlet set with the inlet.

In some embodiments, for the third collection module in the one or more collection modules, the second outlet set further includes a third outlet (e.g., the third outlet 133) fluidically connected to a downstream system (e.g., the downstream system 172). The control unit is configured to control the operation of the valve of the third collection module to couple the third outlet of the second outlet set with the inlet and thus allow flushing the valve of the third collection module with the fluid. The coupling of the third outlet of the second outlet set with the inlet is performed subsequent to alternately coupling the first outlet and the second outlet of the first outlet set with the inlet but prior to alternately coupling the first outlet and the second outlet of the second outlet set with the inlet.

In some embodiments, for each collection module in the one or more collection modules, at least one outlet set in the one or more outlet sets further includes a third outlet configured to be fluidically connected to a downstream system. In some embodiments, for each collection module in the one or more collection modules, each outlet set in the one or more outlet sets further includes the third outlet configured to be fluidically connected to the downstream system.

In some embodiments, for each collection module in the one or more collection modules, the first container of each respective container set in the one or more container sets is fluidically connected to the first outlet of the corresponding outlet set in the one or more outlet sets through a first filter (e.g., a filter 151), a first disconnection device (e.g., a disconnection device 152), or both. The second container of each respective container set in the one or more container sets is fluidically connected to the second outlet of the corresponding outlet set in the one or more outlet sets through a second filter (e.g., a filter 151), a second disconnection device (e.g., a disconnection device 152), or both.

In some embodiments, for each collection module in the one or more collection modules, the one or more outlet sets of the valve includes one, two, three, four, five, six, seven, eight, nine, ten, or more than ten outlet sets. In some embodiments, for each collection module in the one or more collection modules, the one or more container sets include one, two, three, four, five, six, seven, eight, nine, ten, or more than ten container sets.

In some embodiments, for at least one collection module in the one or more collection modules, the one or more outlet sets of the valve have a same number of sets as the one or more container sets. In some embodiments, for at least one collection module in the one or more collection modules, the one or more outlet sets of the valve have a greater number of sets than the one or more container sets.

In some embodiments, for at least one collection module in the one or more collection modules, the first and second containers of a respective container set in the one or more container sets are configured differently. In some embodiments, the first container of the respective container set in the one or more container sets is configured to collect a first amount of fluid; and the second container of the respective container set in the one or more container sets is configured to collect a second amount of fluid. In some embodiments, the first or second amount of the fluid is collected for sample testing.

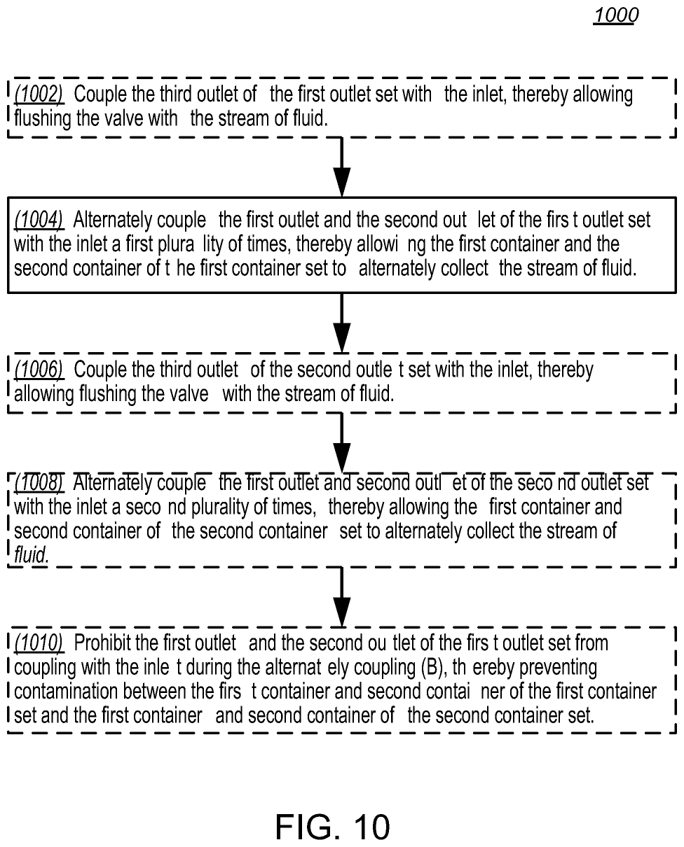

FIG. 10 is a flowchart illustrating an exemplary method, generally designated 1000, in accordance with some exemplary embodiments of the present invention. In FIG. 10, the preferred parts of the method are shown in solid line boxes whereas additional, optional, or alternative parts of the method are shown in dashed line boxes. The method 1000 is configured to control a system, such as any collection module or collection system disclosed herein. The system includes a valve and one or more container sets. The valve includes an inlet for receiving a stream of fluid and one or more outlet sets for fluidically coupling with the one or more container sets. Each of the one or more outlet sets includes a first outlet and a second outlet, and any outlet of any outlet set in the one or more outlet sets is individually selectable for fluidically coupling with the inlet. In addition, each of the one or more container sets includes a first container and a second container, and the first and second containers of a first container set are fluidically connected to the first and second outlets of a first outlet set respectively. In some embodiments, the one or more outlet sets of the valve have a same number of sets as the one or more container sets. In some other embodiments, the one or more outlet sets of the valve have a greater number of sets than the one or more container sets.

Referring to block 1004, the method generally includes (A) alternately coupling the first outlet and the second outlet of the first outlet set with the inlet a first plurality of times, thereby allowing the first container and the second container of the first container set to alternately collect the stream of fluid. In some embodiments, the coupling of the first outlet and the second outlet of the first outlet set with the inlet alternates at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, or at least 100 times.

In some embodiments, at a respective alternation, the coupling of the first outlet of the first outlet set with the inlet lasts for a first period of time and the coupling of the second outlet of the second outlet set with the inlet lasts for a second period of time. In some embodiments, the first period of time is determined based at least in part on (i) a total amount of fluid to be collected by the first container of the first container set, (ii) a current amount of fluid in the first container of the first container set, (iii) a rate of filling the first container of the first container set, or any combination thereof. Similarly, the second period of time is determined based at least in part on (i) a total amount of fluid to be collected by the second container of the first container set, (ii) a current amount of fluid in the second container of the first container set, (iii) a rate of filling the second container of the first container set, or any combination thereof.

In some embodiments, the first container of the first container set is configured to collect a first amount of fluid, and the second container of the first container set is configured to collect a second amount of fluid. In some embodiments, the first or second amount of the fluid is collected for sample testing.

Referring to block 1002, in some embodiments, the first outlet set further includes a third outlet fluidically connected to a downstream system. In some such embodiments, the method further includes (B) coupling, prior to the alternately coupling (A), the third outlet of the first outlet set with the inlet, thereby allowing flushing the valve with the stream of fluid.

Referring to block 1008, in some embodiments, the one or more outlet sets further include a second outlet set, the one or more container sets further include a second container set, and the first and second containers of the second container set are fluidically connected to the first and second outlets of the second outlet set respectively. In some such embodiments, the method further includes (C) alternately coupling, subsequent to the alternately coupling (A), the first outlet and second outlet of the second outlet set with the inlet a second plurality of times, thereby allowing the first container and second container of the second container set to alternately collect the stream of fluid. In an embodiment, the second plurality of times is the same as the first plurality of times. In another embodiment, the second plurality of times is different than the first plurality of times.

Referring to block 1006, in some embodiments, the second outlet set further includes a third outlet fluidically connected to the downstream system. In some such embodiments, the method further includes (D) coupling, subsequent to the alternately coupling (A) but prior to the alternately coupling (C), the third outlet of the second outlet set with the inlet, thereby allowing flushing the valve with the stream of fluid.

Referring to block 1010, in some embodiments, the method further includes (E) prohibiting the first outlet and the second outlet of the first outlet set from coupling with the inlet during the alternately coupling (B), thereby preventing contamination between the first container and second container of the first container set and the first container and second container of the second container set.

### Exemplary Implements

Implement 1. A collection system comprising one or more collection modules, each collection module in the one or more collection modules comprising: a valve comprising an inlet and one or more outlet sets, wherein each outlet set in the one or more outlet sets comprises a first outlet and a second outlet, and any outlet of any outlet set in the one or more outlet sets is individually selectable for fluidically coupling with the inlet; and one or more container sets, wherein each respective container set in the one or more container sets comprises a first container fluidically connected to the first outlet of a corresponding outlet set in the one or more outlet sets and a second container fluidically connected to the second outlet of the corresponding outlet set in the one or more outlet sets, wherein for a first collection module in the one or more collection modules: (i) the inlet of the valve is configured to be fluidically connected to an upstream system to receive a first stream of fluid from the upstream system, (ii) the one or more outlet sets comprise a first outlet set, (iii) the one or more container sets comprise a first container set, (iv) the first container of the first container set is fluidically connected to the first outlet of the first outlet set, and (v) the second container of the first container set is fluidically connected to the second outlet of the first outlet set; and a control unit electrically connected to the valve of each collection module in the one or more collection modules and configured to control operation of the valve of each collection module in the one or more collection modules, wherein for the first collection module in the one or more collection modules, the control of operation of the valve comprises alternately coupling the first outlet and the second outlet of the first outlet set with the inlet a first plurality of times, thereby allowing the first container and the second container of the first container set to alternately collect the first stream of fluid.

Implement 2. The collection system of Implement 1, wherein the fluid comprises proteins, peptides, cells, nucleic acids, vaccines, diagnostics, reagents, raw materials, biopolymers, carbohydrates, polysaccharides, lipids, biosynthetic molecules, molecules produced by biocatalysis or enzymatic production, or any combination thereof.

Implement 3. The collection system of any preceding Implement, wherein the fluid comprises a biological component.

Implement 4. The collection system of Implement 3, wherein the biological component is a biopharmaceutical or vaccine product or a component of the biopharmaceutical or vaccine product.

Implement 5. The collection system of Implement 4, wherein the biopharmaceutical product comprises proteins, peptides, cells, nucleic acids, vaccines, biopolymers, carbohydrates, polysaccharides, lipids, biosynthetic molecules, molecules produced by biocatalysis or enzymatic production, or any combination thereof.

Implement 6. The collection system of any preceding Implement, wherein for each collection module in the one or more collection modules, at least one outlet set in the one or more outlet sets further comprises a third outlet configured to be fluidically connected to a downstream system.

Implement 7. The collection system of Implement 6, wherein for each collection module in the one or more collection modules, each outlet set in the one or more outlet sets further comprises the third outlet configured to be fluidically connected to the downstream system.

Implement 8. The collection system of any preceding Implement, wherein for each collection module in the one or more collection modules: the first container of each respective container set in the one or more container sets is fluidically connected to the first outlet of the corresponding outlet set in the one or more outlet sets through a first filter, a first disconnection device, or both; and the second container of each respective container set in the one or more container sets is fluidically connected to the second outlet of the corresponding outlet set in the one or more outlet sets through a second filter, a second disconnection device, or both.

Implement 9. The collection system of any preceding Implement, wherein for each collection module in the one or more collection modules, the one or more outlet sets of the valve comprises one, two, three, four, five, six, seven, eight, nine, ten, or more than ten outlet sets.

Implement 10. The collection system of any preceding Implement, wherein for each collection module in the one or more collection modules, the one or more container sets comprise one, two, three, four, five, six, seven, eight, nine, ten, or more than ten container sets.

Implement 11. The collection system of any preceding Implement, wherein for at least one collection module in the one or more collection modules, the one or more outlet sets of the valve have a same number of sets as the one or more container sets.

Implement 12. The collection system of any preceding Implement, wherein for at least one collection module in the one or more collection modules, the one or more outlet sets of the valve have a greater number of sets than the one or more container sets.

Implement 13. The collection system of any preceding Implement, wherein for at least one collection module in the one or more collection modules, the first and second containers of a respective container set in the one or more container sets are configured differently.

Implement 14. The collection system of Implement 13, wherein: the first container of the respective container set in the one or more container sets is configured to collect a first amount of fluid; and the second container of the respective container set in the one or more container sets is configured to collect a second amount of fluid.

Implement 15. The collection system of Implement 14, wherein the first or second amount of the fluid is collected for sample testing.

Implement 16. The collection system of any preceding Implement, wherein for at least one collection module in the one or more collection modules, the first or second container of a respective container set in the one or more container sets is a bag, a bottle or a carboy.

Implement 17. The collection system of any preceding Implement, wherein for the first collection module in the one or more collection modules, the coupling of the first outlet and the second outlet of the first outlet set with the inlet alternates at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, or at least 100 times.

Implement 18. The collection system of any preceding Implement, wherein for the first collection module in the one or more collection modules and at a respective alternation, the coupling of the first outlet of the first outlet set with the inlet lasts for a first period of time and the coupling of the second outlet of the first outlet set with the inlet lasts for a second period of time.

Implement 19. The collection system of Implement 18, wherein: the first period of time is determined based at least in part on (i) a total amount of fluid to be collected by the first container of the first container set, (ii) a current amount of fluid in the first container of the first container set, (iii) a rate of filling the first container of the first container set, or any combination thereof; and the second period of time is determined based at least in part on (i) a total amount of fluid to be collected by the second container of the first container set, (ii) a current amount of fluid in the second container of the first container set, (iii) a rate of filling the second container of the first container set, or any combination thereof.

Implement 20. The collection system of any preceding Implement, wherein for the first collection module in the one or more collection modules: the first outlet set further comprises a third outlet fluidically connected to a downstream system; and the control of operation of the valve comprises, prior to alternately coupling the first outlet and the second outlet of the first outlet set with the inlet, coupling the third outlet of the first outlet set with the inlet, thereby allowing flushing the valve with the first stream of fluid.

Implement 21. The collection system of any preceding Implement, wherein for the first collection module in the one or more collection modules: the one or more outlet sets further comprise a second outlet set; the one or more container sets further comprise a second container set; the first container of the second container set is fluidically connected to the first outlet of the second outlet set; the second container of the second container set is fluidically connected to the second outlet of the first outlet set; and the control of operation of the valve further comprises, subsequent to alternately coupling the first outlet and the second outlet of the first outlet set with the inlet, alternately coupling the first outlet and second outlet of the second outlet set with the inlet a second plurality of times, thereby allowing the first container and second container of the second container set to alternately collect the first stream of fluid.

Implement 22. The collection system of Implement 21, wherein for the first collection module in the one or more collection modules, the coupling of the first and second outlets of the second outlet set with the inlet alternates at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, or at least 100 times.

Implement 23. The collection system of any one of Implements 21-22, wherein for the first collection module in the one or more collection modules: the second outlet set further comprises a third outlet fluidically connected to a downstream system; and the control of operation of the valve comprises, subsequent to alternately coupling the first outlet and the second outlet of the first outlet set with the inlet but prior to alternately coupling the first outlet and the second outlet of the second outlet set with the inlet, coupling the third outlet of the second outlet set with the inlet, thereby allowing flushing the valve with the first stream of fluid.

Implement 24. The collection system of any preceding Implement, wherein the one or more collection modules consist of the first collection module.

Implement 25. The collection system of any one of Implement 1-23, wherein the one or more collection modules comprises two, three, four, five, six or more than six collection modules.

Implement 26. The collection system of Implement 25, wherein the one or more collection modules comprises the first collection module and a second collection module.

Implement 27. The collection system of Implement 26, wherein the one or more outlet sets of the valve of the second collection module have a same number of sets as the one or more outlet sets of the valve of the first collection module.

Implement 28. The collection system of Implement 26, wherein the one or more outlet sets of the valve of the second collection module have a different number of sets than the one or more outlet sets of the valve of the first collection module.

Implement 29. The collection system of any one of Implements 26-28, wherein the one or more container sets of the second collection module have a same number of sets as the one or more container sets of the first collection module.

Implement 30. The collection system of any one of Implements 26-28, wherein the one or more container sets of the second collection module have a different number of sets than the one or more container sets of the first collection module.

Implement 31. The collection system of any one of Implements 26-30, wherein for the second collection module in the one or more collection modules: the inlet of the valve is configured to be fluidically connected to the upstream system to receive a second stream of fluid from the upstream system; the one or more outlet sets comprise a first outlet set; the one or more container sets comprise a first container set; the first container of the first container set is fluidically connected to the first outlet of the first outlet set; the second container of the first container set is fluidically connected to the second outlet of the first outlet set; and the control of operation of the valve comprises alternately coupling the first outlet and the second outlet of the first outlet set with the inlet a third plurality of times, thereby allowing the first container and the second container of the first container set to alternately collect the second stream of fluid.

Implement 32. The collection system of Implement 31, wherein for the second collection module in the one or more collection modules: the first outlet set further comprises a third outlet fluidically connected to a downstream system; and the control of operation of the valve comprises, prior to alternately coupling the first outlet and the second outlet of the first outlet set with the inlet, coupling the third outlet of the first outlet set with the inlet, thereby allowing flushing the valve with the second stream of fluid.

Implement 33. The collection system of Implement 31 or 32, wherein for the second collection module in the one or more collection modules: the one or more outlet sets further comprise a second outlet set; the one or more container sets further comprise a second container set; the first container of the second container set is fluidically connected to the first outlet of the second outlet set; the second container of the second container set is fluidically connected to the second outlet of the first outlet set; and the control of operation of the valve further comprises, subsequent to alternately coupling the first outlet and the second outlet of the first outlet set with the inlet, alternately coupling the first outlet and second outlet of the second outlet set with the inlet a fourth plurality of times, thereby allowing the first container and second container of the second container set to alternately collect the second stream of fluid.

Implement 34. The collection system of Implement 33, wherein for the second collection module in the one or more collection modules: the second outlet set further comprises a third outlet fluidically connected to a downstream system; and the control of operation of the valve comprises, subsequent to alternately coupling the first outlet and the second outlet of the first outlet set with the inlet but prior to alternately coupling the first outlet and the second outlet of the second outlet set with the inlet, coupling the third outlet of the second outlet set with the inlet, thereby allowing flushing the valve with the second stream of fluid.

Implement 35. The collection system of any one of Implements 31-34, wherein the control of operation of the valve of the first collection module and the control of operation of the valve of the second collection module are independent from each other.

Implement 36. The collection system of any one of Implements 31-35, wherein the inlet of the valve of the first collection module and the inlet of the valve of the second collection module are fluidically connected to the upstream system through a common upstream connector.

Implement 37. The collection system of any one of Implements 31-35, wherein the inlet of the valve of the first collection module and the inlet of the valve of the second collection module are fluidically connected to the upstream system through different upstream connectors.

Implement 38. The collection system of any one of Implements 26-30, wherein for the first collection module in the one or more collection modules: the valve further comprises a transfer outlet; and the control of operation of the valve comprises coupling the transfer outlet with the inlet; and wherein for the second collection module in the one or more collection modules: the inlet of the valve is fluidically connected to the transfer outlet of the valve of the first collection module to receive the first stream of fluid; the one or more outlet sets comprise a first outlet set; the one or more container sets comprise a first container set; the first container of the first container set is fluidically connected to the first outlet of the first outlet set; the second container of the first container set is fluidically connected to the second outlet of the first outlet set; and the control of operation of the valve comprises alternately coupling the first outlet and the second outlet of the first outlet set with the inlet a fifth plurality of times, thereby allowing the first container and the second container of the first container set to alternately collect the first stream of fluid.

Implement 39. The collection system of Implement 38, wherein for the second collection module in the one or more collection modules: the first outlet set further comprises a third outlet fluidically connected to a downstream system; and the control of operation of the valve comprises, prior to alternately coupling the first outlet and the second outlet of the first outlet set with the inlet, coupling the third outlet of the first outlet set with the inlet, thereby allowing flushing the valve with the first stream of fluid.

Implement 40. The collection system of Implement 38 or 39, wherein for the second collection module in the one or more collection modules: the one or more outlet sets further comprise a second outlet set; the one or more container sets further comprise a second container set; the first container of the second container set is fluidically connected to the first outlet of the second outlet set; the second container of the second container set is fluidically connected to the second outlet of the first outlet set; and the control of operation of the valve further comprises, subsequent to alternately coupling the first outlet and the second outlet of the first outlet set with the inlet, alternately coupling the first outlet and second outlet of the second outlet set with the inlet a sixth plurality of times, thereby allowing the first container and second container of the second container set to alternately collect the first stream of fluid.

Implement 41. The collection system of Implement 40, wherein for the second collection module in the one or more collection modules: the second outlet set further comprises a third outlet fluidically connected to a downstream system; and the control of operation of the valve comprises, subsequent to alternately coupling the first outlet and the second outlet of the first outlet set with the inlet but prior to alternately coupling the first outlet and the second outlet of the second outlet set with the inlet, coupling the third outlet of the second outlet set with the inlet, thereby allowing flushing the valve with the first stream of fluid.

Implement 42. The collection system of any one of Implements 26-41, wherein the one or more collection modules comprises the first collection module, the second collection module and a third collection module.

Implement 43. The collection system of Implement 42, wherein the control of operation of the valve of the third connection module is independent of the control of operation of the valve of the first collection module, the control of operation of the valve of the second collection module, or both.

Implement 44. The collection system of Implement 42 or 43, wherein for the third collection module in the one or more collection modules: the inlet of the valve is configured to be fluidically connected to the upstream system to receive a third stream of fluid from the upstream system; the one or more outlet sets comprise a first outlet set; the one or more container sets comprise a first container set; the first container of the first container set is fluidically connected to the first outlet of the first outlet set; the second container of the first container set is fluidically connected to the second outlet of the first outlet set; and the control of operation of the valve comprises alternately coupling the first outlet and the second outlet of the first outlet set with the inlet a seventh plurality of times, thereby allowing the first container and the second container of the first container set to alternately collect the third stream of fluid.

Implement 45. The collection system of Implement 44, wherein for the third collection module in the one or more collection modules: the first outlet set further comprises a third outlet fluidically connected to a downstream system; and the control of operation of the valve comprises, prior to alternately coupling the first outlet and the second outlet of the first outlet set with the inlet, coupling the third outlet of the first outlet set with the inlet, thereby allowing flushing the valve with the third stream of fluid.

Implement 46. The collection system of Implement 44 or 45, wherein for the third collection module in the one or more collection modules: the one or more outlet sets further comprise a second outlet set; the one or more container sets further comprise a second container set; the first container of the second container set is fluidically connected to the first outlet of the second outlet set; the second container of the second container set is fluidically connected to the second outlet of the first outlet set; and the control of operation of the valve further comprises, subsequent to alternately coupling the first outlet and the second outlet of the first outlet set with the inlet, alternately coupling the first outlet and second outlet of the second outlet set with the inlet an eighth plurality of times, thereby allowing the first container and second container of the second container set to alternately collect the third stream of fluid.

Implement 47. The collection system of Implement 46, wherein for the third collection module in the one or more collection modules: the second outlet set further comprises a third outlet fluidically connected to a downstream system; and the control of operation of the valve comprises, subsequent to alternately coupling the first outlet and the second outlet of the first outlet set with the inlet but prior to alternately coupling the first outlet and the second outlet of the second outlet set with the inlet, coupling the third outlet of the second outlet set with the inlet, thereby allowing flushing the valve with the third stream of fluid.

Implement 48. The collection system of any preceding Implement, wherein: each outlet set in the one or more outlet sets comprises at least one additional outlet; each respective container set in the one or more container sets comprises at least one additional container, wherein each of the at least one additional container is fluidically connected to a corresponding additional outlet in the at least one additional outlet of a corresponding outlet set in the one or more outlet sets; and for the first collection module in the one or more collection modules, the control of operation of the valve comprises alternately coupling the first outlet, the second outlet, and each of the at least one additional outlet of the first outlet set with the inlet the first plurality of times, thereby allowing the first container, the second container, and each of the at least one additional container of the first container set to alternately collect the first stream of fluid.

Implement 49. The collection system of Implement 48, wherein: each outlet set in the one or more outlet sets comprises one, two, three, four or five additional outlets; and each respective container set in the one or more container sets comprises one, two, three, four, or five additional containers.

Implement 50. A method for controlling the collection system of any preceding Implement.

Implement 51. A method for controlling a collection system, wherein (i) the collection system comprises a valve and one or more container sets, (ii) the valve comprises an inlet for receiving a stream of fluid and one or more outlet sets for fluidically coupling with the one or more container sets, (iii) each of the one or more outlet sets comprises a first outlet and a second outlet, (iv) any outlet of any outlet set in the one or more outlet sets is individually selectable for fluidically coupling with the inlet, (v) each of the one or more container sets comprises a first container and a second container, and (vi) the first and second containers of a first container set are fluidically connected to the first and second outlets of a first outlet set respectively, the method comprising: (A) alternately coupling the first outlet and the second outlet of the first outlet set with the inlet a first plurality of times, thereby allowing the first container and the second container of the first container set to alternately collect the stream of fluid.

Implement 52. The method of Implement 51, wherein the coupling of the first outlet and the second outlet of the first outlet set with the inlet alternates at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, or at least 100 times.

Implement 53. The method of Implement 51 or 52, wherein at a respective alternation, the coupling of the first outlet of the first outlet set with the inlet lasts for a first period of time and the coupling of the second outlet of the second outlet set with the inlet lasts for a second period of time.

Implement 54. The method of Implement 53, wherein: the first period of time is determined based at least in part on (i) a total amount of fluid to be collected by the first container of the first container set, (ii) a current amount of fluid in the first container of the first container set, (iii) a rate of filling the first container of the first container set, or any combination thereof; and the second period of time is determined based at least in part on (i) a total amount of fluid to be collected by the second container of the first container set, (ii) a current amount of fluid in the second container of the first container set, (iii) a rate of filling the second container of the first container set, or any combination thereof.

Implement 55. The method of any one of Implements 51-54, wherein: the first container of the first container set is configured to collect a first amount of fluid; and the second container of the first container set is configured to collect a second amount of fluid.

Implement 56. The method of Implement 55, wherein the first or second amount of the fluid is collected for sample testing.

Implement 57. The method of any one of Implements 51-56, wherein the first outlet set further comprises a third outlet fluidically connected to a downstream system, the method further comprising: (B) coupling, prior to the alternately coupling (A), the third outlet of the first outlet set with the inlet, thereby allowing flushing the valve with the stream of fluid.

Implement 58. The method of any one of Implements 51-57, wherein the one or more outlet sets further comprise a second outlet set, the one or more container sets further comprise a second container set, and the first and second containers of the second container set are fluidically connected to the first and second outlets of the second outlet set respectively, the method further comprising: (C) alternately coupling, subsequent to the alternately coupling (A), the first outlet and second outlet of the second outlet set with the inlet a second plurality of times, thereby allowing the first container and second container of the second container set to alternately collect the stream of fluid.

Implement 59. The method of Implement 58, wherein the second plurality of times is the same as the first plurality of times.

Implement 60. The method of Implement 58, wherein the second plurality of times is different than the first plurality of times.

Implement 61. The method of any one of Implements 51-60, wherein the second outlet set further comprises a third outlet fluidically connected to the downstream system, the method further comprising: (D) coupling, subsequent to the alternately coupling (A) but prior to the alternately coupling (C), the third outlet of the second outlet set with the inlet, thereby allowing flushing the valve with the stream of fluid.

Implement 62. The method of any one of Implements 58-61, further comprising: (E) prohibiting the first outlet and the second outlet of the first outlet set from coupling with the inlet during the alternately coupling (B), thereby preventing contamination between the first container and second container of the first container set and the first container and second container of the second container set.

Implement 63. The method of any one of Implements 51-62, wherein the one or more outlet sets of the valve have a same number of sets as the one or more container sets.

Implement 64. The method of any one of Implements 51-62, wherein the one or more outlet sets of the valve have a greater number of sets than the one or more container sets.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

What is claimed is:

1. A collection system comprising:
one or more collection modules, each collection module in the one or more collection modules comprising:
a valve comprising an inlet and one or more outlet sets, wherein each outlet set in the one or more outlet sets comprises a first outlet and a second outlet, and any outlet of any outlet set in the one or more outlet sets is individually selectable for fluidically coupling with the inlet; and
one or more container sets, wherein each respective container set in the one or more container sets comprises a first container fluidically connected to the first outlet of a corresponding outlet set in the one or more outlet sets and a second container fluidically connected to the second outlet of the corresponding outlet set in the one or more outlet sets,
wherein for a first collection module in the one or more collection modules: (i) the inlet of the valve is configured to be fluidically connected to an upstream system to receive a first stream of fluid from the upstream system, (ii) the one or more outlet sets comprise a first outlet set, (iii) the one or more container sets comprise a first container set, (iv) the first container of the first container set is fluidically connected to the first outlet of the first outlet set, and (v) the second container of the first container set is fluidically connected to the second outlet of the first outlet set; and
a control unit electrically connected to the valve of each collection module in the one or more collection modules and configured to control operation of the valve of each collection module in the one or more collection modules,
wherein for the first collection module in the one or more collection modules, the control of operation of the valve comprises alternately coupling the first outlet and the second outlet of the first outlet set with the inlet a first plurality of times, thereby allowing the first container and the second container of the first container set to alternately collect the first stream of fluid.

2. The collection system of claim 1, wherein the fluid comprises proteins, peptides, cells, nucleic acids, vaccines, diagnostics, reagents, raw materials, biopolymers, carbohydrates, polysaccharides, lipids, biosynthetic molecules, molecules produced by biocatalysis or enzymatic production, or any combination thereof.

3. The collection system of claim 1, wherein for each collection module in the one or more collection modules, at least one outlet set in the one or more outlet sets further comprises a third outlet configured to be fluidically connected to a downstream system.

4. The collection system of claim 3, wherein for each collection module in the one or more collection modules, each outlet set in the one or more outlet sets further comprises the third outlet configured to be fluidically connected to the downstream system.

5. The collection system of claim 1, wherein for each collection module in the one or more collection modules:
the first container of each respective container set in the one or more container sets is fluidically connected to the first outlet of the corresponding outlet set in the one or more outlet sets through a first filter, a first disconnection device, or both; and
the second container of each respective container set in the one or more container sets is fluidically connected to the second outlet of the corresponding outlet set in the one or more outlet sets through a second filter, a second disconnection device, or both.

6. The collection system of claim 1, wherein for at least one collection module in the one or more collection modules, the first and second containers of a respective container set in the one or more container sets are configured differently.

7. The collection system of claim 6, wherein:
the first container of the respective container set in the one or more container sets is configured to collect a first amount of fluid; and
the second container of the respective container set in the one or more container sets is configured to collect a second amount of fluid.

8. The collection system of claim 7, wherein the first or second amount of the fluid is collected for sample testing.

9. The collection system of claim 1, wherein for at least one collection module in the one or more collection modules, the first or second container of a respective container set in the one or more container sets is a bag, a bottle or a carboy.

10. The collection system of claim 1, wherein for the first collection module in the one or more collection modules and at a respective alternation, the coupling of the first outlet of the first outlet set with the inlet lasts for a first period of time and the coupling of the second outlet of the first outlet set with the inlet lasts for a second period of time.

11. The collection system of claim 10, wherein:
the first period of time is determined based at least in part on (i) a total amount of fluid to be collected by the first container of the first container set, (ii) a current amount of fluid in the first container of the first container set, (iii) a rate of filling the first container of the first container set, or any combination thereof; and
the second period of time is determined based at least in part on (i) a total amount of fluid to be collected by the second container of the first container set, (ii) a current amount of fluid in the second container of the first container set, (iii) a rate of filling the second container of the first container set, or any combination thereof.

12. The collection system of claim 1, wherein for the first collection module in the one or more collection modules:
the first outlet set further comprises a third outlet fluidically connected to a downstream system; and
the control of operation of the valve comprises, prior to alternately coupling the first outlet and the second outlet of the first outlet set with the inlet, coupling the third outlet of the first outlet set with the inlet, thereby allowing flushing the valve with the first stream of fluid.

13. The collection system of claim 1, wherein for the first collection module in the one or more collection modules:
the one or more outlet sets further comprise a second outlet set;
the one or more container sets further comprise a second container set;
the first container of the second container set is fluidically connected to the first outlet of the second outlet set;
the second container of the second container set is fluidically connected to the second outlet of the first outlet set; and
the control of operation of the valve further comprises, subsequent to alternately coupling the first outlet and the second outlet of the first outlet set with the inlet, alternately coupling the first outlet and second outlet of the second outlet set with the inlet a second plurality of times, thereby allowing the first container and second container of the second container set to alternately collect the first stream of fluid.

14. The collection system of claim 13, wherein for the first collection module in the one or more collection modules, the coupling of the first and second outlets of the second outlet set with the inlet alternates at least 2 times, at least 3 times, at least 4 times, at least 5 times, at least 10 times, at least 15 times, at least 20 times, at least 30 times, at least 40 times, at least 50 times, at least 60 times, at least 70 times, at least 80 times, at least 90 times, or at least 100 times.

15. The collection system of claim 13, wherein for the first collection module in the one or more collection modules:
the second outlet set further comprises a third outlet fluidically connected to a downstream system; and
the control of operation of the valve comprises, subsequent to alternately coupling the first outlet and the second outlet of the first outlet set with the inlet but prior to alternately coupling the first outlet and the second outlet of the second outlet set with the inlet, coupling the third outlet of the second outlet set with the inlet, thereby allowing flushing the valve with the first stream of fluid.

16. The collection system of claim 1, wherein the one or more collection modules comprises the first collection module and a second collection module.

17. The collection system of claim 16, wherein for the second collection module in the one or more collection modules:
the inlet of the valve is configured to be fluidically connected to the upstream system to receive a second stream of fluid from the upstream system;
the one or more outlet sets comprise a first outlet set;
the one or more container sets comprise a first container set;
the first container of the first container set is fluidically connected to the first outlet of the first outlet set;
the second container of the first container set is fluidically connected to the second outlet of the first outlet set; and
the control of operation of the valve comprises alternately coupling the first outlet and the second outlet of the first outlet set with the inlet a third plurality of times, thereby allowing the first container and the second container of the first container set to alternately collect the second stream of fluid.

18. The collection system of claim 17, wherein for the second collection module in the one or more collection modules:
the first outlet set further comprises a third outlet fluidically connected to a downstream system; and
the control of operation of the valve comprises, prior to alternately coupling the first outlet and the second outlet of the first outlet set with the inlet, coupling the third outlet of the first outlet set with the inlet, thereby allowing flushing the valve with the second stream of fluid.

19. The collection system of claim 18, wherein for the second collection module in the one or more collection modules:
the one or more outlet sets further comprise a second outlet set;
the one or more container sets further comprise a second container set;
the first container of the second container set is fluidically connected to the first outlet of the second outlet set;
the second container of the second container set is fluidically connected to the second outlet of the first outlet set; and
the control of operation of the valve further comprises, subsequent to alternately coupling the first outlet and the second outlet of the first outlet set with the inlet, alternately coupling the first outlet and second outlet of the second outlet set with the inlet a fourth plurality of times, thereby allowing the first container and second container of the second container set to alternately collect the second stream of fluid.

20. The collection system of claim 19, wherein for the second collection module in the one or more collection modules:
the second outlet set further comprises a third outlet fluidically connected to a downstream system; and
the control of operation of the valve comprises, subsequent to alternately coupling the first outlet and the second outlet of the first outlet set with the inlet but prior to alternately coupling the first outlet and the second outlet of the second outlet set with the inlet, coupling the third outlet of the second outlet set with the inlet, thereby allowing flushing the valve with the second stream of fluid.
